(19) United States
(12) Patent Application Publication
(10) Pub. No.: US 2025/0335827 A1
(43) Pub. Date: Oct. 30, 2025

(54) TRANSLATION MODEL TRAINING AND TEXT TRANSLATION

(71) Applicant: Tencent Technology (Shenzhen) Company Limited, Shenzhen (CN)

(72) Inventors: Xianfeng ZENG, Shenzhen (CN); Yijin LIU, Shenzhen (CN); Fandong MENG, Shenzhen (CN)

(73) Assignee: Tencent Technology (Shenzhen) Company Limited, Shenzhen (CN)

(21) Appl. No.: 19/262,028

(22) Filed: Jul. 7, 2025

Related U.S. Application Data
(63) Continuation of application No. PCT/CN2024/072220, filed on Jan. 15, 2024.

(30) Foreign Application Priority Data
Apr. 3, 2023 (CN) 202310367742.7

(51) Int. Cl. G06N 20/00; G06F 40/58

(52) U.S. Cl. CPC G06N 20/00; G06F 40/58

(57) ABSTRACT

In a method for training a translation model, sample text is obtained. Feature extraction is performed based on the sample text sequentially through n cascaded encoding sub-models to obtain encoding features. Feature extraction is performed based on the encoding features sequentially through m cascaded decoding sub-models to obtain decoding features. A sample translation result of the sample text is predicted based on the decoding features. A reference translation result of the sample text is obtained. An error between the reference translation result and the sample translation result is determined. A model parameter of the translation model according to the error is updated.

### RELATED APPLICATIONS

The present application is a continuation of International Application No. PCT/CN2024/072220, filed on Jan. 15, 2024, which claims priority to Chinese Patent Application No. 202310367742.7, filed on Apr. 3, 2023. The entire disclosures of the prior applications are hereby incorporated by reference.

### FIELD OF THE TECHNOLOGY

This application relates to the field of computer technologies, including a method for training a translation model and a text translation method.

### BACKGROUND OF THE DISCLOSURE

Machine translation enables communication between individuals without language barriers, thereby promoting economic and cultural exchanges among nations and regions, and facilitating the mutual dissemination of various kinds of knowledge.

In related technologies, a transformer model is typically employed to perform text translation tasks. The transformer model includes an encoder and a decoder. The encoder and the decoder both have a structure of multiple layers (commonly six layers). According to different positions of layer normalization (LayerNorm) layers in each layer, the implementation of each layer in the encoder and decoder of the transformer model may be classified into two types, i.e., pre-layer normalization (Pre-LN) and post-layer normalization (Post-LN).

The transformer model based on Post-LN has superior performance and generalization capabilities. However, compared to the transformer model based on Pre-LN, the Post-LN-based model has poorer training stability and is prone to collapse during the training process, particularly when the number of model layers is large. This limitation restricts the performance of the translation model, resulting in poor text translation quality.

### SUMMARY

Aspects of this disclosure include a method for training a translation model, a text translation method, and a text translation apparatus.

Examples of technical solutions of this disclosure may be implemented as follows:

An aspect of this disclosure provides a method for training a translation model. Sample text is obtained. Feature extraction is performed based on the sample text sequentially through n cascaded encoding sub-models to obtain encoding features. n is a positive integer greater than or equal to 2. Each encoding sub-model of the n cascaded encoding sub-models includes a layer normalization (LayerNorm) layer and a sub-network layer connected in cascade. The feature extraction through each encoding sub-model includes extracting features sequentially through the LayerNorm layer and the sub-network layer and processing the extracted features through a residual connection between input and output positions of the LayerNorm layer of the respective encoding sub-model. Feature extraction is performed based on the encoding features sequentially through m cascaded decoding sub-models to obtain decoding features. m is a positive integer greater than or equal to 3. Each decoding sub-model of the m cascaded decoding sub-models includes a layer normalization (LayerNorm) layer and a sub-network layer connected in cascade. The feature extraction through each decoding sub-model includes extracting features sequentially through the LayerNorm layer and the sub-network layer and processing the extracted features through a residual connection between input and output positions of the LayerNorm layer of the respective decoding sub-model. A sample translation result of the sample text is predicted based on the decoding features. A reference translation result of the sample text is obtained. An error between the reference translation result and the sample translation result is determined. A model parameter of the translation model according to the error is updated.

An aspect of this disclosure provides a text translation method using a translation model. To-be-translated text is obtained. Feature extraction is performed based on the to-be-translated text sequentially through n cascaded encoding sub-models to obtain encoding features. n is a positive integer greater than or equal to 2. Each encoding sub-model of the n cascaded encoding sub-models includes a layer normalization (LayerNorm) layer and a sub-network layer connected in cascade. The feature extraction through each encoding sub-model includes extracting features sequentially through the LayerNorm layer and the sub-network layer and processing the extracted features through a residual connection between input and output positions of the LayerNorm layer of the respective encoding sub-model. Feature extraction is performed based on the encoding features sequentially through m cascaded decoding sub-models to obtain decoding features. m is a positive integer greater than or equal to 3. Each decoding sub-model of the m cascaded decoding sub-models includes a layer normalization (LayerNorm) layer and a sub-network layer connected in cascade. The feature extraction through each decoding sub-model includes extracting features sequentially through the LayerNorm layer and the sub-network layer and processing the extracted features through a residual connection between input and output positions of the LayerNorm layer of the respective decoding sub-model. A predicted translation result of the to-be-translated text is predicted based on the decoding features.

An aspect of this disclosure provides a text translation apparatus using a translation model, and including processing circuitry. The processing circuitry is configured to obtain to-be-translated text. The processing circuitry is configured to perform feature extraction based on the to-be-translated text sequentially through n cascaded encoding sub-models to obtain encoding features. n is a positive integer greater than or equal to 2. Each encoding sub-model of the n cascaded encoding sub-models includes a layer normalization (LayerNorm) layer and a sub-network layer connected in cascade. The feature extraction through each encoding sub-model including extracting features sequentially through the LayerNorm layer and the sub-network layer and processing the extracted features through a residual connection between input and output positions of the LayerNorm layer of the respective encoding sub-model. The processing circuitry is configured to perform feature extraction based on the encoding features sequentially through m cascaded decoding sub-models to obtain decoding features. m is a positive integer greater than or equal to 3. Each decoding sub-model of the m cascaded decoding sub-models includes a layer normalization (LayerNorm) layer and a sub-network layer connected in cascade. The feature extraction through each decoding sub-model includes extracting features sequentially through the LayerNorm layer and the sub-network layer and processing the extracted features through a residual connection between input and output positions of the LayerNorm layer of the respective decoding sub-model. The processing circuitry is configured to predict a predicted translation result of the to-be-translated text based on the decoding features.

An aspect of this disclosure provides a method for training a translation model, performed by a computer device, the translation model including n cascaded encoding sub-models and m cascaded decoding sub-models, each encoding sub-model and each decoding sub-model including a layer normalization (LayerNorm) layer and a sub-network layer connected in cascade, n being a positive integer greater than or equal to 2, m being a positive integer greater than or equal to 3, and the method including: obtaining sample text; performing feature extraction sequentially through each encoding sub-model of the n encoding sub-models based on the sample text, to obtain an encoding feature, where each encoding sub-model is configured to perform the feature extraction sequentially through the included LayerNorm layer and sub-network layer, and process a feature extraction result of the encoding sub-model through a residual connection between input and output positions of the included LayerNorm layer; and performing the feature extraction sequentially through each decoding sub-model of the m decoding sub-models based on the encoding feature, to obtain a decoding feature, where each decoding sub-model is configured to perform the feature extraction sequentially through the included LayerNorm layer and sub-network layer, and process a feature extraction result of the decoding sub-model through the residual connection; predicting a sample translation result of the sample text according to the decoding feature; and obtaining an actual translation result of the sample text, determining an error between the actual translation result and the sample translation result, and updating a model parameter of the translation model according to the error.

An aspect of this disclosure provides a text translation method based on a translation model, performed by a computer device, the translation model including n cascaded encoding sub-models and m cascaded decoding sub-models, each encoding sub-model and each decoding sub-model including a LayerNorm layer and a sub-network layer connected in cascade, n being a positive integer greater than or equal to 2, m being a positive integer greater than or equal to 3, and the method including: obtaining to-be-translated text; performing feature extraction sequentially through each encoding sub-model of the n encoding sub-models based on the to-be-translated text, to obtain an encoding feature, where each encoding sub-model is configured to perform the feature extraction sequentially through the included LayerNorm layer and sub-network layer, and process a feature extraction result of the encoding sub-model through a residual connection between input and output positions of the included LayerNorm layer; and performing the feature extraction sequentially through each decoding sub-model of the m decoding sub-models based on the encoding feature, to obtain a decoding feature, where each decoding sub-model is configured to perform the feature extraction sequentially through the included LayerNorm layer and sub-network layer, and process a feature extraction result of the decoding sub-model through the residual connection; and predicting a predicted translation result of the to-be-translated text according to the decoding feature.

An aspect of this disclosure provides a training apparatus for a translation model, the translation model including n cascaded encoding sub-models and m cascaded decoding sub-models, each encoding sub-model and each decoding sub-model including a LayerNorm layer and a sub-network layer connected in cascade, n being a positive integer greater than or equal to 2, m being a positive integer greater than or equal to 3, and the apparatus including: an obtaining module, configured to obtain sample text; an input/output module, configured to perform feature extraction sequentially through each encoding sub-model of the n encoding sub-models based on the sample text, to obtain an encoding feature, where each encoding sub-model is configured to perform the feature extraction sequentially through the included LayerNorm layer and sub-network layer, and process a feature extraction result of the encoding sub-model through a residual connection between input and output positions of the included LayerNorm layer, and the input/output module is further configured to perform the feature extraction sequentially through each decoding sub-model of the m decoding sub-models based on the encoding feature, to obtain a decoding feature, where each decoding sub-model is configured to perform the feature extraction sequentially through the included LayerNorm layer and sub-network layer, and process a feature extraction result of the decoding sub-model through the residual connection; a prediction module, configured to predict a sample translation result of the sample text according to the decoding feature; and a training module, configured to obtain an actual translation result of the sample text, determine an error between the actual translation result and the sample translation result, and update a model parameter of the translation model according to the error.

An aspect of this disclosure provides a training apparatus for a translation model, the translation model including n cascaded encoding sub-models and m cascaded decoding sub-models, each encoding sub-model and each decoding sub-model including a LayerNorm layer and a sub-network layer connected in cascade, n being a positive integer greater than or equal to 2, m being a positive integer greater than or equal to 3, and the apparatus including: an obtaining module, configured to obtain sample text; an input/output module, configured to perform feature extraction sequentially through each encoding sub-model of the n encoding sub-models based on the sample text, to obtain an encoding feature, where each encoding sub-model is configured to perform the feature extraction sequentially through the included LayerNorm layer and sub-network layer, and process a feature extraction result of the encoding sub-model through a residual connection between input and output positions of the included LayerNorm layer, and the input/output module is further configured to perform the feature extraction sequentially through each decoding sub-model of the m decoding sub-models based on the encoding feature, to obtain a decoding feature, where each decoding sub-model is configured to perform the feature extraction sequentially through the included LayerNorm layer and sub-network layer, and process a feature extraction result of the decoding sub-model through the residual connection; a prediction module, configured to predict a sample translation result of the sample text according to the decoding feature; and a training module, configured to obtain an actual translation result of the sample text, determine an error between the actual translation result and the sample translation result, and update a model parameter of the translation model according to the error.

An aspect of this disclosure provides a computer device, including a processor and a memory, the memory having at least one instruction, at least one program, a code set, or an instruction set stored therein, and the at least one instruction, the at least one program, the code set, or the instruction set is loaded and executed by the processor to implement the training method for the translation model or the text translation method based on the translation model as described above.

An aspect of this disclosure provides a non-transitory computer-readable storage medium, having computer-executable instructions stored therein, the computer-executable instructions, when executed by a processor, cause the processor to implement the virtual ray processing method provided in the aspects of this disclosure.

An aspect of this disclosure provides a computer program product or a computer program, the computer program product or the computer program including a computer instruction, and the computer instruction being stored in a computer-readable storage medium. A processor of a computer device reads the computer instruction from the computer-readable storage medium, and the processor executes the computer instruction to enable the computer device to implement the training method for the translation model or the text translation method based on the translation model provided in the aspects of this disclosure.

Details of one or more aspects of this disclosure are provided in the accompanying drawings and descriptions below. Other features, objectives, and advantages of this disclosure become apparent from the specification, the drawings, and the claims.

### BRIEF DESCRIPTION OF THE DRAWINGS

To describe the technical solutions in aspects of this disclosure, the following briefly describes the accompanying drawings. The accompanying drawings in the following descriptions show merely examples of aspects of this disclosure, and a person of ordinary skill in the art may still derive other drawings from these disclosed accompanying drawings.

FIG. 1 is a schematic structural diagram of a transformer model according to an aspect of this disclosure.

FIG. 2 is a schematic structural diagram of post-layer normalization (Post-LN) and pre-layer normalization (Pre-LN) according to an aspect of this disclosure.

FIG. 3 is a block diagram of a computer system according to an aspect of this disclosure.

FIG. 4 is a schematic structural diagram of a translation model according to an aspect of this disclosure.

FIG. 5 is a flowchart of a training method for a translation model according to an aspect of this disclosure.

FIG. 6 is a flowchart of a training method for a translation model according to an aspect of this disclosure.

FIG. 7 is a schematic structural diagram of an encoding model according to an aspect of this disclosure.

FIG. 8 is a schematic structural diagram of a decoding model according to an aspect of this disclosure.

FIG. 9 is a flowchart of a text translation method based on a translation model according to an aspect of this disclosure.

FIG. 10 is a schematic diagram of a text translation process according to an aspect of this disclosure.

FIG. 11 is a schematic diagram of a chat interface according to an aspect of this disclosure.

FIG. 12 is a schematic structural diagram of a training apparatus for a translation model according to an aspect of this disclosure.

FIG. 13 is a schematic structural diagram of a text translation apparatus based on a translation model according to an aspect of this disclosure.

FIG. 14 is a schematic structural diagram of a computer device according to an aspect of this disclosure.

Accompanying drawings herein are incorporated into the specification and constitute a part of this specification, show aspects that conform to this disclosure, and are configured for describing a principle of this disclosure together with this specification.

### DETAILED DESCRIPTION

The technical solutions in aspects of this disclosure are described in the following with reference to the accompanying drawings in the aspects of this disclosure. The described aspects are merely some rather than all of the aspects of this disclosure. All other aspects obtained by a person of ordinary skill in the art based on the aspects of this disclosure shall fall within the scope of this disclosure. Further, the descriptions of the terms are provided as examples only and are not intended to limit the scope of the disclosure.

First, several terms involved in the aspects of this disclosure are introduced.

Transformer model: a translation model based on an encoder-decoder architecture and proposed in 2017.

Pre-layer normalization (Pre-LN): also referred to as Pre-Norm, and may refer to a variation of the transformer model.

Post-layer normalization (Post-LN): also referred to as Post-Norm, and may refer to a variation of a transformer model.

Residual connection: a structure used by the transformer model for stabilizing model training, and divides the model into two branches: a main branch and an identity branch.

Bilingual evaluation understudy (BLEU): a method for measuring similarity between text, and usually used to evaluate translation quality.

Machine translation enables communication between individuals without language barriers, thereby promoting economic and cultural exchanges among nations and regions, and facilitating the mutual dissemination of various kinds of knowledge. In related technologies, a transformer model is typically employed to perform text translation tasks. The traditional transformer model includes an encoder and a decoder. The encoder and the decoder both have a structure of multiple layers (commonly six layers).

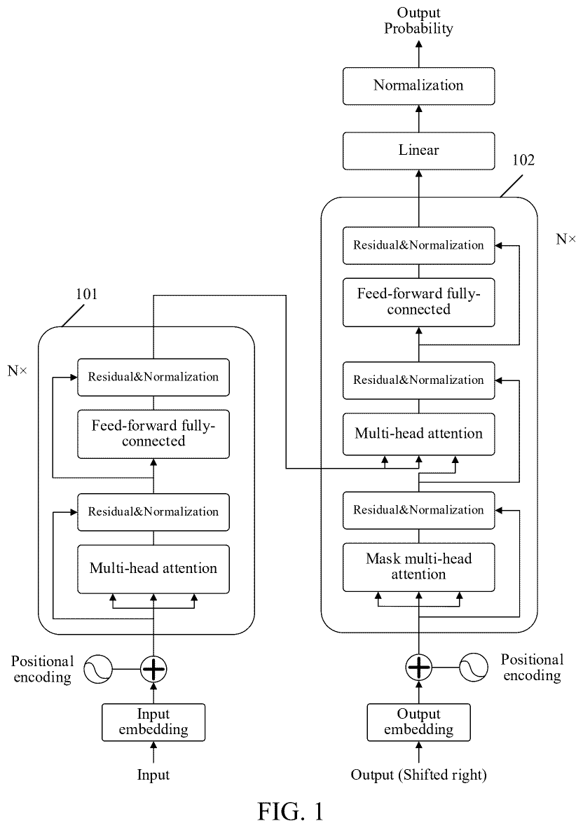

For example, FIG. 1 is a schematic structural diagram of a transformer model according to an aspect of this disclosure. As shown in FIG. 1, the transformer model includes an encoder 101 and a decoder 102. The encoder 101 and the decoder 102 have a structure of N layers (which may be considered as a structure in which N models are cascaded). A structure of each layer of the encoder 101 is consistent, a structure of each layer of the decoder 102 is consistent, and a structure of each layer of the encoder 101 is similar to that of the decoder 102.

Each layer of the encoder 101 usually includes a multi-head self-attention module (that may also be referred to as a multi-head self-attention network), i.e., “multi-head attention” on the left in FIG. 1. Each layer of the encoder further includes a feed-forward fully-connected module (also referred to as a feed-forward network (FFN)), i.e., “feed-forward fully-connected” on the left in FIG. 1.

Each layer of the decoder 102 usually includes a mask multi-head self-attention module (which may also be referred to as a mask multi-head self-attention network), i.e., “mask multi-head attention” at the lower right side in FIG. 1. Each layer of the decoder further includes a self-attention module (also referred to as a cross self-attention module, and a cross self-attention network, that may be considered as a multi-head self-attention module) crossing the encoder and the decoder, i.e., “multi-head attention” in the right middle part of FIG. 1. Each layer of the decoder further includes a feed-forward fully-connected module, i.e., “feed-forward fully-connected network” at the upper right side in FIG. 1.

The multi-head self-attention module of the encoder 101 is configured to obtain a weight relationship between each word in inputted text and other words in the inputted text. The feed-forward fully-connected module of the encoder 101 is configured to perform nonlinear transformation on an input feature. The mask multi-head self-attention module of the decoder 102 functions similarly to the multi-head self-attention module of the encoder 101, with a distinction that prevents the decoder 102, when generating a word in the inputted text, from obtaining a translation result (the translation result corresponding to the inputted text at the lower right corner of the model in FIG. 1 during the training) corresponding to a word after the word in the inputted text. The cross self-attention module of the decoder 102 functions similarly to the multi-head self-attention module of the encoder 101, with a distinction that a received input is formed by output information of a preceding module in the decoder 102 and output information of a last layer in the encoder 101. The feed-forward fully-connected module of the decoder 102 functions similarly to the feed-forward fully-connected module of the encoder 101.

In addition, further referring to FIG. 1, each of the foregoing modules (the multi-head self-attention module and the feed-forward fully-connected module) in the encoder 101 and the decoder 102 of the transformer model needs a residual connection and a layer normalization (LayerNorm) layer (namely, an Add&Norm in FIG. 1). The residual connection may be considered as a structure enabling an output of a module of the model to be used as an input of a subsequent non-adjacent module, and is configured for reducing model complexity and preventing a gradient from disappearing. The LayerNorm layer is configured to perform normalized processing, such as normalization processing, on the inputted information. The foregoing structures of the residual connection and the LayerNorm layer are both configured to stabilize the training of the model.

According to different positions of layer normalization (LayerNorm) layers in each layer of the encoder and decoder of the transformer model, the implementation of each layer in the encoder and decoder of the transformer model may be classified into two types, i.e., pre-layer normalization (Pre-LN) and post-layer normalization (Post-LN).

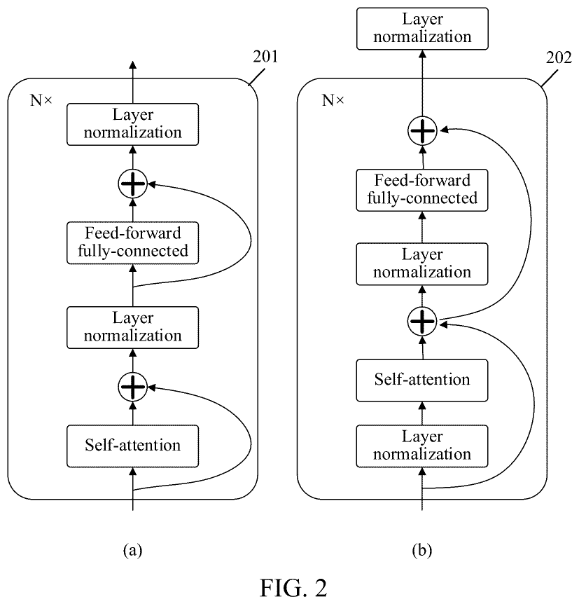

For example, FIG. 2 is a schematic structural diagram of Post-LN and Pre-LN according to an aspect of this disclosure. As shown in (a) of FIG. 2, in an encoder 201 of the Post-LN-based transformer model, the LayerNorm layers corresponding to the self-attention module and the feed-forward fully-connected module are both set subsequent to the module. As shown in (b) of FIG. 2, in an encoder 202 of the Pre-LN-based transformer model, the LayerNorm layers corresponding to the self-attention module and a feed-forward fully-connected module are both set before the module. In addition, there is a difference between a position of the residual connection in the encoder 201 and a position of the residual connection in the decoder 202 (an arc arrow in the figure). In addition, regarding a structural difference of the decoder of the transformer model based on Pre-LN and Post-LN, refer to FIG. 2. This is because the decoder of the transformer model may be regarded as an extension of the encoder with the addition of a “layer normalization and multi-head self-attention module”. This is not described herein again in this aspect of this disclosure.

To obtain a better translation effect, usually, more high-quality data needs to be provided in a model training process, or a parameter quantity of the model needs to be increased, for example, the number of layers of the encoder and the decoder of the transformer model increases. However, the increase of the number of layers usually means instability of training, because a gradient signal needs to propagate through a longer path. The transformer model based on Post-LN has superior performance and generalization capabilities. However, compared to the transformer model based on Pre-LN, the Post-LN-based model has poorer training stability and is prone to collapse during the training process, particularly when the number of model layers is large. The Pre-LN-based transformer model inherently has excellent stability and can be trained stably under various layer settings. However, compared with the transformer model based on the Post-LN, the transformer model based on the Pre-LN has problems of a poor effect and poor generalization. Further referring to FIG. 1, it can be learned that a conventional transformer model is based on the Post-LN. Therefore, the training stability is relatively poor. Consequently, the performance of the translation model is limited, and the text translation quality is relatively poor.

This aspect of this disclosure provides a translation model combining Pre-LN and Post-LN. The translation model can be stably trained in a scenario of an extremely deep layer (1000 layers), and has an effect similar to that of the transformer model based on the Post-LN. The translation model provided in this aspect of this disclosure significantly solves the training stability problem of the Post-LN, and provides an appropriate solution for the model structure in the scenario of extremely deep architectures. The translation model provided in this aspect of this disclosure at least has the following beneficial effects:

(1) By combining forms of Pre-LN and Post-LN, the residual connection of the Pre-LN provides a channel for stably propagating a gradient signal, to ensure that the translation model can be successfully trained and converged as the number of layers increases, thereby improving the stability of the model.

(2) The residual connection of the Post-LN ensures complexity of transformation inside the translation model, and has an effect on machine translation that is comparable to that of the Post-LN.

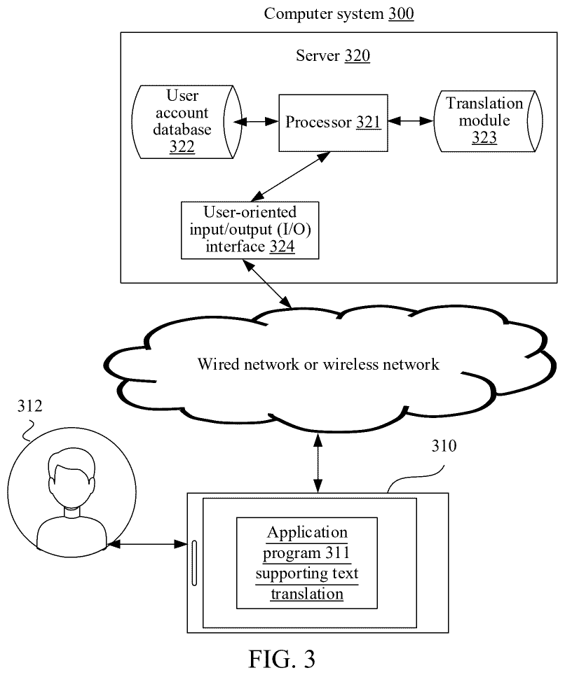

FIG. 3 is a block diagram of a computer system according to an aspect of this disclosure. The computer system 300 includes: a terminal 310 and a server 320.

An application program 311 (a client) supporting text translation is installed and run on the terminal 310. The application program 311 can provide a function of translating text in one language into the text in one or more other languages. For example, the application program 311 may be any one of an instant messaging client, a social client, a medical client, a financial client, a short video client, a video-on-demand client, a music client, a takeout client, an online shopping client, a knowledge client, or a tool client. When the terminal 310 call the application program 311 to run, a user interface of the application program 311 is displayed on a screen of the terminal 310. The terminal 310 is a terminal used by a user 312, and a user account of the user 312 is logged in the application program 311. The terminal 310 may be one of a plurality of terminals. In some aspects, a device type of the terminal 310 includes: at least one of a smart phone, a tablet computer, an e-book reader, a moving picture experts group audio layer III (MP3) player, a moving picture experts group audio layer IV (MP4) player, a portable laptop computer, and a desktop computer.

The terminal 310 is connected to the server 320 through a wireless network or a wired network.

The server 320 includes at least one of one server, a plurality of servers, a cloud computing platform, and a virtualization center. The server 320 is configured to provide a backend service for the application program 311 supporting text translation. In some aspects, the server 320 is responsible for primary computing work, and the terminal 310 is responsible for secondary computing work. Alternatively, the server 320 is responsible for the secondary computing work, and the terminal 310 is responsible for the primary computing work. Alternatively, a distributed computing architecture may be used between the server 320 and the terminal 310 for collaborative computing.

For example, the server 320 includes a processor 321, a user account database 322, a translation module 323, and a user-oriented input/output (I/O) interface 324. The processor 321 is configured to load an instruction stored in the server 320 and process data in the user account database 322 and the translation module 323. The user account database 322 is configured to store data of user accounts used by the terminal 310 and another terminal, such as avatars of the user accounts, nicknames of the user accounts, and groups to which the user accounts belong. The translation module 323 is configured to translate the obtained text. The user-oriented I/O interface 324 is configured to establish communication with the terminal 310 through a wireless network or a wired network for data exchange.

In some aspects, the method provided in this aspect of this disclosure is implemented by the application program 311. In this case, the translation model provided in this aspect of this disclosure may be integrated into the application program 311, and the application program 311 may independently perform operations in this aspect of this disclosure. In some aspects, the method provided in this aspect of this disclosure is applied to the server 320. In this case, the translation model provided in this aspect of this disclosure is integrated into the server 320, and the server 320 may independently perform operations in this aspect of this disclosure. In some aspects, the method provided in this aspect of this disclosure may be cooperatively implemented by the application program 311 and the server 320. For example, the server 320 may obtain the text transmitted by the application program 311, translate the obtained text, and then feed a translation result of the text back to the application program 311.

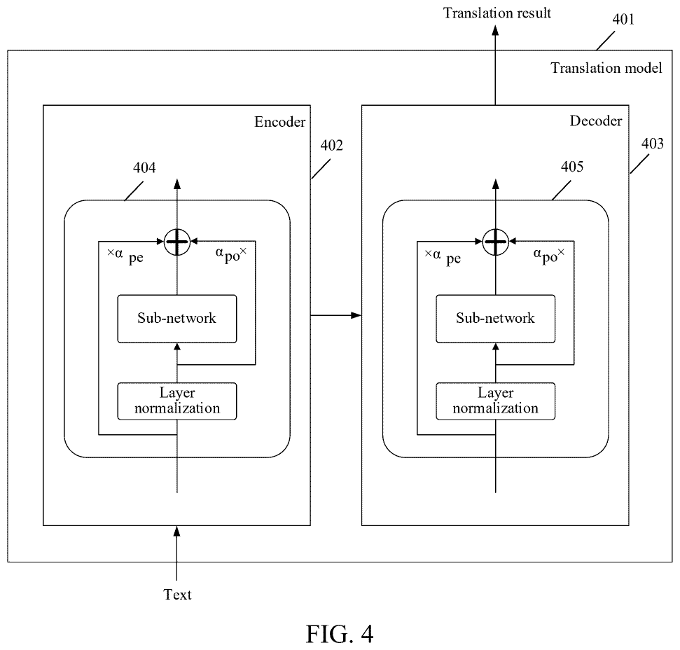

FIG. 4 is a schematic structural diagram of a translation model according to an aspect of this disclosure. As shown in FIG. 4, the translation model 401 includes an encoder 402 and a decoder 403 connected in cascade. The encoder 402 includes k cascaded encoding models, the decoder 403 includes k cascaded decoding models, the structure of each encoding model is the same, the structure of each decoding model is the same, and k is a positive integer greater than or equal to 2. The encoding model includes at least two cascaded encoding sub-models 404, and the decoding model includes at least three cascaded decoding sub-models 405. In some aspects, the encoding model includes two cascaded encoding sub-models 404, and the decoding model includes three cascaded decoding sub-models 405.

The encoding sub-model 404 and the decoding sub-model 405 both include cascaded units. Each unit includes a layer normalization (LayerNorm) layer and a sub-network layer. The LayerNorm layer in each unit is before the sub-network layer, and the sub-network layer is one of a feed-forward fully-connected network and a multi-head self-attention network. In some aspects, in the encoder 402, the sub-network layer in a first encoding sub-model 404 of the encoding model is a multi-head self-attention network, and the sub-network layer in a second encoding sub-model 404 is a feed-forward fully-connected network. In the decoder 402, the sub-network layer in a first decoding sub-model 405 of the decoding model is a mask multi-head self-attention network, the sub-network layer in a second decoding sub-model 405 is a cross self-attention network, and the sub-network layer in a third decoding sub-model 405 is a feed-forward fully-connected network. In addition, input and output positions of the LayerNorm layer in the encoding sub-model 404 and the decoding sub-model 405 have residual connections. For example, further referring to FIG. 4, the residual connection in the encoding sub-model 404 can add an input of the encoding sub-model 404 (an input of the LayerNorm layer) and an output of the LayerNorm layer with an output of the sub-network layer, where a result of the addition is an input of a next encoding sub-model 404. For the residual connection in the decoding sub-model 405, refer to descriptions of the residual connection in the encoding sub-model 404, and details are not described herein again. Positions of the LayerNorm layers in the encoding sub-model 404 and the decoding sub-model 405 are set similarly to the Pre-LN, and the residual connection set on this basis is similar to the Post-LN. Therefore, the forms of Pre-LN and Post-LN are combined.

In a training stage, the computer device obtains sample text and inputs the sample text to the translation model 401, to predict a sample translation result of the sample text, then obtains an actual translation result of the sample text, determines an error between the actual translation result and the sample translation result, and trains the translation model 401 according to the error. In an application phase, the computer device obtains to-be-translated text, and inputs the to-be-translated text to the translation model 401, so as to predict a predicted translation result of the to-be-translated text, thereby implementing the translation of the to-be-translated text.

The translation model is constructed by using the encoding sub-model and the decoding sub-model. Because the LayerNorm layer in each sub-model is before the sub-network layer, and the input and output positions of the LayerNorm layer in each sub-model have the residual connections, the residual connection of Post-LN is introduced based on the Pre-LN. The residual connection provides a channel for stably propagating a gradient signal, which ensures that the translation model can further be successfully trained and converged as the number of layers of the translation model increases (namely, k increases), thereby improving the stability of the model. In addition, the structure similar to the Pre-LN in the translation model can further ensure a better effect and generalization performance of the translation model. Therefore, the performance of the translation model can be improved, thereby improving the text translation quality.

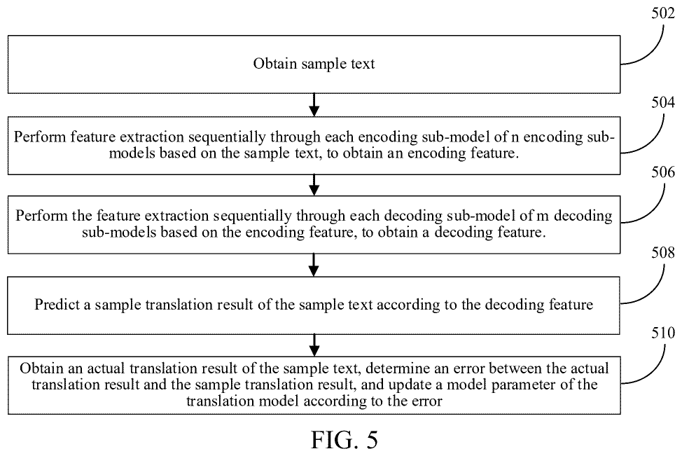

FIG. 5 is a flowchart of a training method for a translation model according to an aspect of this disclosure. The method may be applied to a computer device or a client in the computer device. As shown in FIG. 5, the method includes:

Operation 502: Obtain sample text. For example, sample text is obtained.

The sample text is configured for training a translation model. In some aspects, the computer device may further obtain an actual translation result of the sample text when obtaining the sample text. The sample text includes one or more pieces of text, and the actual translation result includes one or more pieces of text. A language used by the sample text is different from the language used by the actual translation result, and the actual translation result is text obtained after the sample text is translated. For example, the sample text may be “JIN TIAN TIAN QI ZEN ME YANG” in Chinese, and the actual translation result may be “What's the weather like today” in English. “Actual” in the actual translation result may mean that it is confirmed that the actual translation result really belongs to a result obtained after the sample text is translated.

In some aspects, the translation model is configured to translate the text in one or more first languages into the text in one or more second languages, and the language used by the sample text belongs to the one or more first languages, and the language used by the actual translation result belongs to the one or more second languages.

In some aspects, the computer device obtains the sample text and the actual translation result by means of local storage, the computer device obtains the sample text and the actual translation result by using another computer device, the computer device obtains the sample text and the actual translation result that are uploaded by a user, and/or the computer device obtains the sample text and the actual translation result through a public database.

Operation 504: Perform feature extraction based on the sample text sequentially through each encoding sub-model of the n encoding sub-models, to obtain an encoding feature. For example, feature extraction is performed based on the sample text sequentially through n cascaded encoding sub-models to obtain encoding features. n is a positive integer greater than or equal to 2. Each encoding sub-model of the n cascaded encoding sub-models includes a layer normalization (LayerNorm) layer and a sub-network layer connected in cascade. The feature extraction through each encoding sub-model includes extracting features sequentially through the LayerNorm layer and the sub-network layer and processing the extracted features through a residual connection between input and output positions of the LayerNorm layer of the respective encoding sub-model.

In some aspects, the computer device may input the sample text into the translation model. The translation model performs the feature extraction on the sample text by using a first encoding sub-model of the n encoding sub-models, to output a feature, and then starting from the second encoding sub-model of the n encoding sub-models, performs the feature extraction based on the feature outputted by the preceding encoding sub-model, until the last encoding sub-model of the n encoding sub-models outputs the encoding feature. The encoding feature may be an output feature of the n^{th} encoding sub-model.

In some aspects, the computer device may utilize the translation model to perform the feature extraction on the sample text by using the first encoding sub-model of the n encoding sub-models to output the feature, and then starting from the second encoding sub-model of the n encoding sub-models, perform the feature extraction based on the features outputted by the encoding sub-models preceding the current encoding sub-model, until the last encoding sub-model of the n encoding sub-models outputs the encoding feature.

In some aspects, the computer device may further utilize the translation model to perform the feature extraction on the sample text by using the first encoding sub-model of the n encoding sub-models, to output the feature, then starting from the second encoding sub-model of the n encoding sub-models, sequentially fuse the features outputted by the encoding sub-models preceding the current encoding sub-model for feature extraction, and fuse the features outputted respectively by the n encoding sub-models, to obtain the encoding feature.

In some aspects, before the n encoding sub-models extract the features, the translation model may alternatively perform some pre-processing on the sample text, for example perform normalization and/or initial feature extraction on the sample text.

The translation model includes n cascaded encoding sub-models, each encoding sub-model includes a LayerNorm layer and a sub-network layer connected in cascade, and n is a positive integer greater than or equal to 2. In some aspects, the sub-network layer is one of a feed-forward fully-connected network and a multi-head self-attention network. The n encoding sub-models at least include one feed-forward fully-connected network and one multi-head self-attention network. The sub-network layers in two adjacent encoding sub-models are the same or different. The LayerNorm layer is configured to perform normalized processing, such as normalization processing, on the inputted information. The multi-head self-attention network is configured to calculate a weight relationship between each word in the inputted feature and another word in the inputted feature. The feed-forward fully-connected network is configured to perform nonlinear transformation on the inputted feature.

In a process of performing the feature extraction by using the n encoding sub-models, each encoding sub-model is configured to perform the feature extraction sequentially through the included LayerNorm layer and sub-network layer, and process a feature extraction result of the encoding sub-model through a residual connection between the input and output positions of the included LayerNorm layer. The residual connection may be regarded as a structure enabling an output feature of a module in the translation model to be used as an input feature of a subsequent non-adjacent module, and is configured for reducing the model complexity and preventing a gradient from disappearing.

In some aspects, the translation model includes an encoder, the encoder includes k encoding models, the k encoding models include the n cascaded encoding sub-models, each encoding model includes at least two cascaded encoding sub-models, and k is a positive integer. For example, each encoding model includes two cascaded encoding sub-models, the structure of each encoding model is the same, the sub-network layer of the first encoding sub-model of each encoding model is a multi-head self-attention network, and the sub-network layer of the second encoding sub-model of each encoding model is a feed-forward fully-connected network.

Operation 506: Perform feature extraction based on the encoding feature sequentially through each decoding sub-model of the m decoding sub-models, to obtain a decoding feature. For example, feature extraction is performed based on the encoding features sequentially through m cascaded decoding sub-models to obtain decoding features. m is a positive integer greater than or equal to 3. Each decoding sub-model of the m cascaded decoding sub-models includes a layer normalization (LayerNorm) layer and a sub-network layer connected in cascade. The feature extraction through each decoding sub-model includes extracting features sequentially through the LayerNorm layer and the sub-network layer and processing the extracted features through a residual connection between input and output positions of the LayerNorm layer of the respective decoding sub-model.

In some aspects, the computer device may perform decoding by using a first decoding sub-model of the m decoding sub-models, to output a feature, and then starting from the second decoding sub-model of the m decoding sub-models, perform decoding sequentially based on the feature outputted by preceding decoding sub-model, until the last decoding sub-model of the m decoding sub-models outputs the decoding feature.

In some aspects, the computer device may further perform the decoding by using the first decoding sub-model of the m decoding sub-models, to output the feature, and then starting from the second decoding sub-model of the m decoding sub-models, perform the decoding sequentially based on the features outputted by the decoding sub-models preceding the current decoding sub-model, until the last decoding sub-model of the m decoding sub-models outputs the decoding feature.

In some aspects, the computer device may further perform the decoding by using the first decoding sub-model of the m decoding sub-models, to output the feature, and then starting from the second decoding sub-model of the m decoding sub-models, sequentially fuse the features outputted by the decoding sub-models preceding the current decoding sub-model for decoding, and until the last decoding sub-model of the m decoding sub-models outputs the feature, fuse the features outputted respectively by the m decoding sub-models to obtain the decoding feature.

The translation model includes m cascaded decoding sub-models, each decoding sub-model includes a LayerNorm layer and a sub-network layer connected in cascade, and m is a positive integer greater than or equal to 3. In some aspects, the sub-network layer is one of a feed-forward fully-connected network and a multi-head self-attention network, and the multi-head self-attention network can alternatively be one of a mask multi-head self-attention network and a cross self-attention network. The m decoding sub-models at least include a feed-forward fully-connected network, a mask multi-head self-attention network, and a cross self-attention network. The sub-network layers in two adjacent decoding sub-models are the same or different. The mask multi-head self-attention network functions similarly to the multi-head self-attention network, with a distinction that the mask multi-head self-attention network is further configured to, when generating a translation result of a word in the input feature, shield the translation result corresponding to a word after the word in the input feature. For example, the translation model may input the actual translation result of the sample text into m decoding sub-models during prediction. During the feature extraction, the m decoding sub-models may obtain the actual translation result of a (y−1)^{th} word when extracting the feature of a y^{th} word in the sample text, where y is a positive integer. If the feature of the first word is extracted, information is inputted to instruct the start of the feature extraction, for example, the information is “0”. The cross self-attention network functions similarly to the multi-head self-attention network, with a distinction that the inputted feature received by the cross self-attention network includes the output feature and the encoding feature of a preceding module in the translation model.

In a process of performing the feature extraction by using the m decoding sub-models, each decoding sub-model is configured to perform the feature extraction sequentially through the included LayerNorm layer and sub-network layer, and process the feature extraction result of the decoding sub-model through the residual connection between the input and output positions of the included LayerNorm layer. The residual connection may be regarded as a structure enabling an output feature of a module in the translation model to be used as an input feature of a subsequent non-adjacent module, and is configured for reducing the model complexity and preventing a gradient from disappearing.

In some aspects, the translation model includes a decoder, and the decoder is cascaded to and positioned subsequent to the encoder. The decoder includes k decoding models, the k decoding models are formed by the m cascaded decoding sub-models, each decoding model includes at least three cascaded decoding sub-models, and k is a positive integer. For example, each decoding model includes three cascaded decoding sub-models, the structure of each decoding model is the same, the sub-network layer of the first decoding sub-model of each decoding model is a mask multi-head self-attention network, the sub-network layer of the second decoding sub-model of each decoding model is a cross self-attention network, and the sub-network layer of the third decoding sub-model of each decoding model is a feed-forward fully-connected network.

Operation 508: Predict a sample translation result of the sample text according to the decoding feature. For example, a sample translation result of the sample text is predicted based on the decoding features.

The computer device may predict the sample translation result of the sample text according to the decoding feature through the translation model. In some aspects, the translation model further includes a linear layer and a softmax layer (also referred to as a normalized exponential function layer) connected in cascade. The linear layer and the softmax layer are cascaded. The linear layer is configured to perform linear transformation on an input feature, and the softmax layer is configured to process the input feature by using a normalized exponential function. After obtaining the decoding feature, the computer device inputs the decoding feature to the linear layer, and performs the processing sequentially through the linear layer and the softmax layer, to output a translated word predicted by the translation model for each current word in the sample text and a probability of each translated word. The translated word is determined by the translation model in a vocabulary based on the decoding feature, and the probability of the translated word is configured for reflecting a probability that the translated word is the actual translated word. By using the vocabularies of different languages, the sample text may be translated into the translation result of the language used by the vocabulary.

Operation 510: Obtain an actual translation result of the sample text, determine an error between the actual translation result and the sample translation result, and update a model parameter of the translation model according to the error. For example, a reference translation result of the sample text is obtained. An error between the reference translation result and the sample translation result is determined. A model parameter of the translation model according to the error is updated.

Updating the model parameter of the translation model is to train the translation model. In some aspects, the computer device obtains the actual translation result of the sample text, determines the error between the actual translation result and the sample translation result, constructs an error loss function according to the error, and reduces an error loss through reverse gradient propagation, to update the model parameter of the translation model. When the accuracy of the translation model satisfies a condition, the translation model is trained.

In conclusion, according to the method provided in this aspect, the translation model is constructed by using the encoding sub-models and the decoding sub-models. Because the LayerNorm layer in each sub-model precedes the sub-network layer, and the input and output positions of the LayerNorm layer in the sub-model have the residual connection, the residual connection of the Post-LN is introduced based on the Pre-LN. The residual connection provides a channel for stably propagating a gradient signal, which ensures that the translation model can further be successfully trained and converged as the number of layers of the translation model increases, thereby improving the stability of the model. In addition, the structure similar to the Pre-LN in the translation model can further ensure a better effect and generalization performance of the translation model. Therefore, the performance of the translation model can be improved, thereby improving the text translation quality.

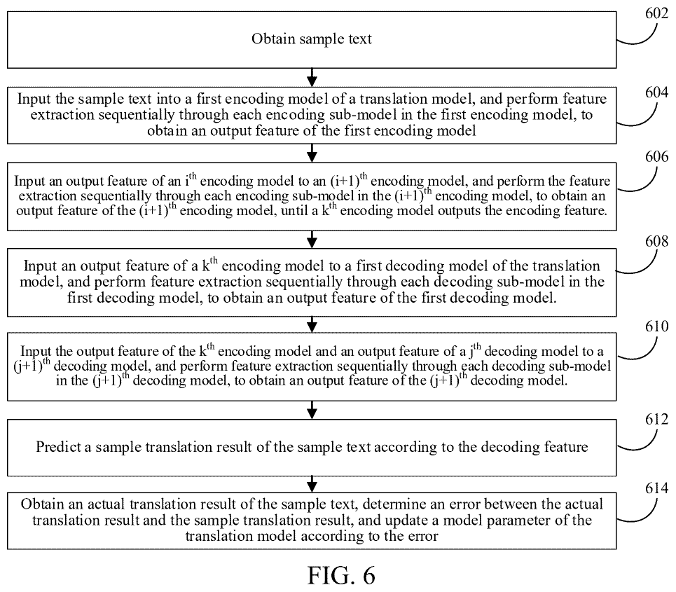

FIG. 6 is a flowchart of a training method for a translation model according to an aspect of this disclosure. The method may be applied to a computer device or a client in the computer device. As shown in FIG. 6, the method includes:

Operation 602: Obtain sample text. For example, sample text is obtained.

The sample text is configured for training a translation model. In some aspects, the computer device may further obtain an actual translation result of the sample text. The sample text includes one or more pieces of text, and the actual translation result includes one or more pieces of text. A language used by the sample text is different from the language used by the actual translation result, and the actual translation result is the text of the sample text in a translated language.

Operation 604: Input the sample text into a first encoding model of the translation model, and perform the feature extraction sequentially through each encoding sub-model in the first encoding model, to obtain an output feature of the first encoding model. For example, the sample text is input into a first encoding model of the k cascaded encoding models. Feature extraction is performed sequentially through each encoding sub-model in the first encoding model to obtain an output feature of the first encoding model.

The translation model includes n cascaded encoding sub-models. Each encoding sub-model includes a LayerNorm layer and a sub-network layer connected in cascade. Further referring to FIG. 4, input and output positions of the LayerNorm layer of each encoding sub-model have a residual connection, and n is a positive integer greater than or equal to 2. In some aspects, the sub-network layer is one of a feed-forward fully-connected network and a multi-head self-attention network. The sub-network layers in two adjacent encoding sub-models are the same or different.

The translation model includes k cascaded encoding models. In some aspects, the k encoding models form an encoder in the translation model. Each encoding model includes at least two cascaded encoding sub-models of the n encoding sub-models, and k is a positive integer greater than or equal to 2. In some aspects, each encoding model includes two cascaded encoding sub-models, and the structure of each encoding model is the same. The sub-network layer of the first encoding sub-model of each encoding model is a multi-head self-attention network, and the sub-network layer of the second encoding sub-model of each encoding model is a feed-forward fully-connected network.

In a process of performing feature extraction by using the encoding model, each encoding sub-model of the encoding model is configured to perform the feature extraction sequentially through the included LayerNorm layer and sub-network layer, and process a feature extraction result of the encoding sub-model through a residual connection between input and output positions of the included LayerNorm layer. For the process of performing the feature extraction by using the first encoding model, refer to the following description of a process of performing the feature extraction by using an (i+1)^{th} encoding model. Details are not described herein again in this aspect of this disclosure.

In some aspects, before inputting the sample text into the first encoding model, the computer device may perform feature embedding processing on the sample text, to obtain an embedding vector. Positional encoding of each word in the sample text is determined, and the positional encoding is configured for reflecting a position of each word in the sample. The computer device adds the embedding vector to the positional encoding, and inputs into the first encoding model of the translation model, to perform a subsequent feature extraction process. For the foregoing process, refer to the example in FIG. 1.

Operation 606: Input an output feature of an i^{th} encoding model to the (i+1)^{th} encoding model, and perform the feature extraction sequentially through each encoding sub-model in the (i+1)^{th} encoding model, to obtain an output feature of the (i+1)^{th} encoding model, until a k^{th} encoding model outputs the encoding feature. For example, an output feature of the first encoding model is input to a second encoding model of the k cascaded encoding models.

i is a positive integer, and i+1 is not greater than k. In some aspects, each encoding model includes a first encoding sub-model and a second encoding sub-model connected in cascade, and the second encoding sub-model is positioned subsequent to the first encoding sub-model. The sub-network layer of the first encoding sub-model is a multi-head self-attention network, and the sub-network layer of the second encoding sub-model is a feed-forward fully-connected network.

In a process of performing the feature extraction sequentially through each encoding sub-model of the (i+1)^{th} encoding model, the computer device inputs the output feature of the i^{th} encoding model to the first encoding sub-model of the (i+1)^{th} encoding model, performs the feature extraction sequentially through the LayerNorm layer and the multi-head self-attention network of the first encoding sub-model, and adds the output feature of the i^{th} encoding model and the output feature of the LayerNorm layer of the first encoding sub-model to the output feature of the multi-head self-attention network of the first encoding sub-model through the residual connection, to obtain the output feature of the first encoding sub-model.

The computer device then inputs the output feature of the first encoding sub-model into the second encoding sub-model of the (i+1)^{th} encoding model, performs the feature extraction sequentially through the LayerNorm layer and the feed-forward fully-connected network of the second encoding sub-model, and adds the output feature of the first encoding sub-model and the output feature of the LayerNorm layer of the second encoding sub-model to the output feature of the feed-forward fully-connected network of the second encoding sub-model through the residual connection, to obtain the output feature of the second encoding sub-model, i.e., the output feature of the (i+1)^{th} encoding model.

In some aspects, in a process of adding the features through the residual connection, the computer device determines a first product of the output feature of the i^{th} encoding model and a first weight, and determines a second product of the output feature of the LayerNorm layer of the first encoding sub-model and a second weight, and then adds the first product and the second product to the output feature of the multi-head self-attention network of the first encoding sub-model through the residual connection. The computer device determines a third product of the output feature of the first encoding sub-model and a third weight, determines a fourth product of the output feature of the LayerNorm layer of the second encoding sub-model and a fourth weight, and adds the third product and the fourth product to the output feature of the feed-forward fully-connected network of the second encoding sub-model through the residual connection.

By cyclically performing this operation, the computer device may perform the feature extraction sequentially by using all encoding models, and the output of the last encoding model is the encoding feature.

For example, a process of adding the output features through the residual connection of the encoding sub-models may be expressed by using the following formula:

$${x}_{l + 1} = F ( L N ( {x}_{l} ) ) + {α}_{p o} L N ( {x}_{l} ) + {α}_{pe} {x}_{l} .$$

In the formula, l is a positive integer. xₗ₊₁ represents the output feature of the l+1^{th} encoding sub-model of the encoding model, and xₗ represents the output feature of the l^{th} encoding sub-model of the encoding model. LN(xₗ) represents the output feature of the LayerNorm layer obtained by performing the feature extraction on xₗ through the LayerNorm layer of the l+1^{th} encoding sub-model, F(LN(xₗ)) represents the output feature of the sub-network layer obtained by performing the feature extraction on the output feature of the LayerNorm layer through the sub-network layer of the l+1^{th} encoding sub-model, αₚₒ is the weight corresponding to LN(xₗ) and may be used as a model parameter determined by training, and αₚₑ is the weight corresponding to xₗ and may be used as the model parameter determined by training.

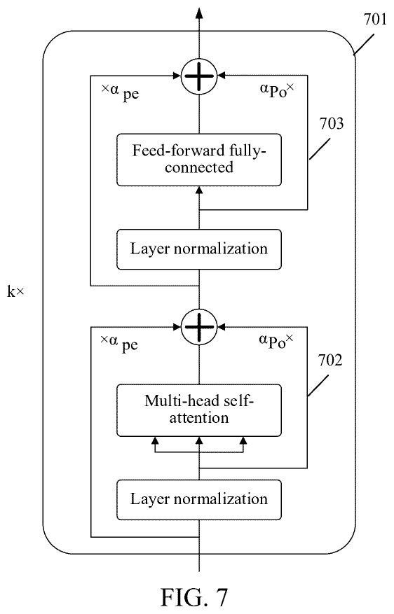

For example, FIG. 7 is a schematic structural diagram of an encoding model according to an aspect of this disclosure. As shown in FIG. 7, the encoding model 701 includes a first encoding sub-model 702 and a second encoding sub-model 703 connected in cascade. The first encoding sub-model 702 includes a LayerNorm layer and a multi-head self-attention network connected in cascade, and the second encoding sub-model 703 includes a LayerNorm layer and a feed-forward fully-connected network connected in cascade. An input of the encoding model 701 is an input of the LayerNorm layer of the first encoding sub-model 702, and an output of the encoding model 701 is an output obtained after the residual connection is performed on the output of the feed-forward fully-connected network of the second encoding sub-model 703. In some aspects, when the output feature of the LayerNorm layer of the first encoding sub-model 702 is inputted into the multi-head self-attention network, the computer device may multiply the output features respectively by a matrix, to obtain a query (Q) vector, a key (K) vector, and a value (V) vector, and input them into the multi-head self-attention network.

Operation 608: Input the output feature of the k^{th} encoding model to a first decoding model of the translation model, and perform feature extraction sequentially through each decoding sub-model in the first decoding model, to obtain an output feature of the first decoding model. For example, the encoding features from a k^{th} encoding model are input to a first decoding model of the k cascaded decoding models. Feature extraction is performed sequentially through each decoding sub-model in the first decoding model to obtain output features of the first decoding model.

The translation model includes m cascaded decoding sub-models. Each decoding sub-model includes a LayerNorm layer and a sub-network layer connected in cascade. Further referring to FIG. 4, input and output positions of the LayerNorm layer of each decoding sub-model have a residual connection, and m is a positive integer greater than or equal to 3. In some aspects, the sub-network layer is one of a feed-forward fully-connected network, a mask multi-head self-attention network, and a cross self-attention network. The sub-network layers in two adjacent decoding sub-models are the same or different.

The translation model includes k cascaded decoding models. In some aspects, the k decoding models form a decoder in the translation model. Each decoding model includes at least three cascaded decoding sub-models of the m decoding sub-models, and k is a positive integer greater than or equal to 2. In some aspects, each decoding model includes three cascaded decoding sub-models, the structure of each decoding model is the same, a sub-network layer of the first decoding sub-model of each decoding model is a mask multi-head self-attention network, the sub-network layer of the second decoding sub-model of each decoding model is a cross self-attention network, and the sub-network layer of the third decoding sub-model of each decoding model is a feed-forward fully-connected network.

In a process of performing feature extraction by using the decoding model, each decoding sub-model of the decoding model is configured to perform the feature extraction sequentially through the included LayerNorm layer and sub-network layer, and process a feature extraction result of the decoding sub-model through a residual connection. For the process of performing the feature extraction by using the first decoding model, refer to the following description of the process of performing the feature extraction by using the (j+1)^{th} decoding model. Details are not described herein again in this aspect of this disclosure.

In some aspects, in a process in which the translation model predicts a translation result, the encoding feature outputted by the last encoding model in the encoder is inputted respectively to each decoding model in the decoder, and each decoding model performs the feature extraction on the encoding feature.

In some aspects, in a training process, the computer device may further input an actual translation result of the sample text to the first encoding model. In some aspects, before inputting the actual translation result into the first decoding model, the computer device may perform feature embedding processing on the actual translation result, to obtain an embedding vector. Positional encoding of each word in the actual translation result is determined, and the positional encoding is configured for reflecting a position of each word in the actual translation result. The computer device adds the embedding vector to the positional encoding, and inputs into the first decoding model of the translation model, thereby performing a subsequent feature extraction process.

In some aspects, in a model training process, when the decoding model extracts the feature vector of the y^{th} word in the sample text, the computer device may input the actual translation result of the (y−1)^{th} word into the first decoding model. If y−1=0, the computer device may input information into the first decoding model to instruct the start of the feature extraction, for example, the information is “0”, and this process may be referred to as shifted right. In an application process of the model, only the information instructing the start of feature extraction needs to be inputted into the first decoding model. For the foregoing process, refer to the example in FIG. 1.

Operation 610: Input an output feature of the k^{th} encoding model and an output feature of the j^{th} decoding model to a (j+1)^{th} decoding model, and perform feature extraction sequentially through each decoding sub-model in the (j+1)^{th} decoding model, to obtain an output feature of the (j+1)^{th} decoding model. For example, the encoding features from the kth encoding model and an output feature of the first decoding model are input to a second decoding model of the k cascaded decoding models.

j is a positive integer and j+1 is not greater than k. In some aspects, each decoding model includes a first decoding sub-model, a second decoding sub-model, and a third decoding sub-model connected in cascade, the second decoding sub-model is positioned subsequent to the first decoding sub-model, and the third decoding sub-model is positioned subsequent to the second decoding sub-model. A sub-network layer of the first decoding sub-model is a first multi-head self-attention network, the sub-network layer of the second decoding sub-model is a second multi-head self-attention network, and the sub-network layer of the third decoding sub-model is a feed-forward fully-connected network.

In a process of performing the feature extraction sequentially through each decoding sub-model in the (j+1)^{th} decoding model, the computer device inputs the output feature of the j^{th} decoding model to the first decoding sub-model of the (j+1)^{th} decoding model, performs the feature extraction sequentially through a LayerNorm layer and the first multi-head self-attention network of the first decoding sub-model, and adds the output feature of the j^{th} decoding model and the output feature of the LayerNorm layer of the first decoding sub-model to the output feature of the first multi-head self-attention network of the first decoding sub-model through the residual connection, to obtain the output feature of the first decoding sub-model. In some aspects, the first multi-head self-attention network is a mask multi-head self-attention network.

The computer device then inputs the output feature of the k^{th} encoding model and the output feature of the first decoding sub-model to the second decoding sub-model of the (j+1)^{th} decoding model, performs the feature extraction sequentially through the LayerNorm layer and the second multi-head self-attention network of the second decoding sub-model, and adds the output feature of the first decoding sub-model and the output feature of the LayerNorm layer of the second decoding sub-model to the output feature of the second multi-head self-attention network of the second decoding sub-model through the residual connection, to obtain the output feature of the second decoding sub-model. In some aspects, the second multi-head self-attention network is a cross self-attention network.

The computer device then inputs the output feature of the second decoding sub-model to the third decoding sub-model of the (j+1)^{th} decoding model, performs the feature extraction sequentially through the LayerNorm layer and the feed-forward fully-connected network of the third decoding sub-model, and adds the output feature of the second decoding sub-model and the output feature of the LayerNorm layer of the third decoding sub-model to the output feature of the feed-forward fully-connected network of the third decoding sub-model through the residual connection, to obtain the output feature of the (j+1)^{th} decoding model.

In some aspects, when the features are added through the residual connection, the added features may be weighted. For example, weights are set respectively for the input and output features of the LayerNorm layer of the decoding sub-model. For a specific implementation process, refer to the process of adding the output features through the residual connection in operation 606. Details are not described herein again in this aspect of this disclosure.

By cyclically performing this operation, the computer device may perform the feature extraction sequentially by using all decoding models, and the output of the last decoding model is the decoding feature.

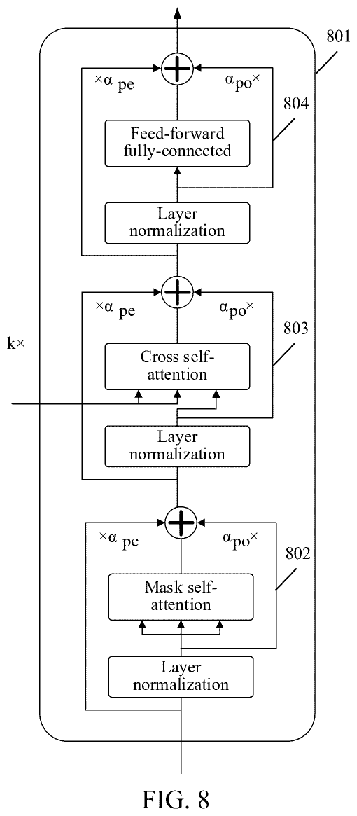

For example, FIG. 8 is a schematic structural diagram of a decoding model according to an aspect of this disclosure. As shown in FIG. 8, the decoding model 801 includes a first decoding sub-model 802, a second decoding sub-model 803, and a third decoding sub-model 804 connected in cascade. The first decoding sub-model 802 includes a LayerNorm layer and a mask multi-head self-attention network connected in cascade, the second decoding sub-model 803 includes a LayerNorm layer and a cross self-attention network connected in cascade, and the third decoding sub-model 804 includes a LayerNorm layer and a feed-forward fully-connected network connected in cascade. There are two cases of an input right below the decoding model 801 in FIG. 8. When the decoding model 801 is the first, for the lower input, refer to the foregoing descriptions for shifted right. When the decoding model 801 is not the first, the lower input is the output feature of a preceding decoding model. An input on the left of the decoding model 801 is the output feature of the last encoding model, but only the Q vector and the K vector in the output feature are inputted, and the V vector is determined according to the output feature of the preceding LayerNorm layer. The output of the decoding model 801 is the output obtained after the residual connection is performed on the output of the feed-forward fully-connected network of the third decoding sub-model 804. In some aspects, a structure of a translation model provided in this aspect of this disclosure may be obtained by replacing the encoder in FIG. 1 with the structure in FIG. 7, and replacing the decoder in FIG. 1 with the structure in FIG. 8.

In some aspects, after the last decoding model completes the feature extraction, the computer device may perform normalized processing on the decoding features outputted by the decoder (i.e., the decoding features outputted by the m decoding sub-models), to obtain normalized decoding features, and then utilize the normalized decoding features to predict a subsequent translation result. In some aspects, the normalized processing may be performed on the decoding features outputted by the decoder by cascading the LayerNorm layer after the decoder.

Operation 612: Predict a sample translation result of the sample text according to the decoding feature. For example, a sample translation result of the sample text is predicted based on the decoding features.

The computer device may predict the sample translation result of the sample text according to the decoding feature through the translation model. In some aspects, the translation model determines a word with the highest probability in the vocabulary of the translation model according to the decoding feature, to obtain the translation result. By using the vocabularies of different languages, the sample text may be translated into the translation result of a language corresponding to the vocabulary.

Operation 614: Obtain an actual translation result of the sample text, determine an error between the actual translation result and the sample translation result, and update a model parameter of the translation model according to the error. For example, a reference translation result of the sample text is obtained. An error between the reference translation result and the sample translation result is determined. A model parameter of the translation model according to the error is updated.

Updating the model parameter of the translation model is to train the translation model. In some aspects, the computer device obtains the actual translation result of the sample text, determines the error between the actual translation result and the sample translation result, constructs an error loss function according to the error, and reduces an error loss through reverse gradient propagation, to update the model parameter of the translation model.

In some aspects, in a training process of the model, the computer device may further obtain the actual translation result of the sample text, determine the error between the actual translation result and the sample translation result, and optimize at least one of a first weight, a second weight, a third weight, and a fourth weight according to the error.

In some aspects, in a case that the number of training iterations of the translation model is not greater than a first threshold, the number of model parameters updated by the translation model in each iteration is set to not exceed a quantity threshold. In the case that the number of training iterations of the translation model is not less than a second threshold, the setting of quantity threshold is canceled, and the second threshold is greater than the first threshold. A parameter updating quantity of the model is set in an early stage of training, and the parameter updating quantity of the model may not be limited in a late stage of training.

In conclusion, according to the method provided in this aspect, the translation model is constructed by using the encoding sub-models and the decoding sub-models. Because the LayerNorm layer in each sub-model precedes the sub-network layer, and the input and output positions of the LayerNorm layer in the sub-model have the residual connection, the residual connection of the Post-LN is introduced based on the Pre-LN. The residual connection provides a channel for stably propagating a gradient signal, which ensures that the translation model can further be successfully trained and converged as the number of layers of the translation model increases (namely, k increases), thereby improving the stability of the model. In addition, the structure similar to the Pre-LN in the translation model can further ensure a better effect and generalization performance of the translation model. Therefore, the performance of the translation model can be improved, thereby improving the text translation quality.

According to the method provided in this aspect, the feature extraction is further performed by using each encoding sub-model in the k encoding models and each decoding sub-model in the k decoding models, to obtain the extracted decoding feature, thereby providing a manner for accurately extracting the decoding feature.

In the method provided in this aspect, the output feature of the sub-network of the encoding sub-model, the input feature of the LayerNorm layer, and the output feature of the LayerNorm layer are further added by using the residual connection in the encoding sub-model, to perform the subsequent feature extraction. The integration of the Post-LN and Pre-LN structures not only ensures the training stability of the translation model, but also ensures that the translation model achieves a better effect and generalization performance.

According to the method provided in this aspect, when the features are added through the residual connection, weights are set for the added features, thereby not only achieving more accurate feature extraction, but also improving the training stability of the model.

According to the method provided in this aspect, in a training process, the weight used when the features are added through the residual connection is further optimized according to the error, so that the weight can be set more accurately, and the model performance can be improved.

According to the method provided in this aspect, normalized processing is further performed on the feature outputted by the last sub-model, to ensure the normalization of the finally outputted feature, thereby ensuring the prediction accuracy of the model.

According to the method provided in this aspect, the output feature of the sub-network of the decoding sub-model, the input feature of the LayerNorm layer, and the output feature of the LayerNorm layer are further added by using the residual connection in the decoding sub-model, to perform the subsequent feature extraction. The integration of the Post-LN and Pre-LN structures not only ensures the training stability of the translation model, but also ensures that the translation model achieves a better effect and generalization performance.

According to the method provided in this aspect, the parameter updating quantity is further limited in the early stage of model training, and the parameter updating quantity is not limited in the late stage of training, to ensure the training stability of the model, and further ensure more sufficient learning of the model, thereby improving the performance release of the model.

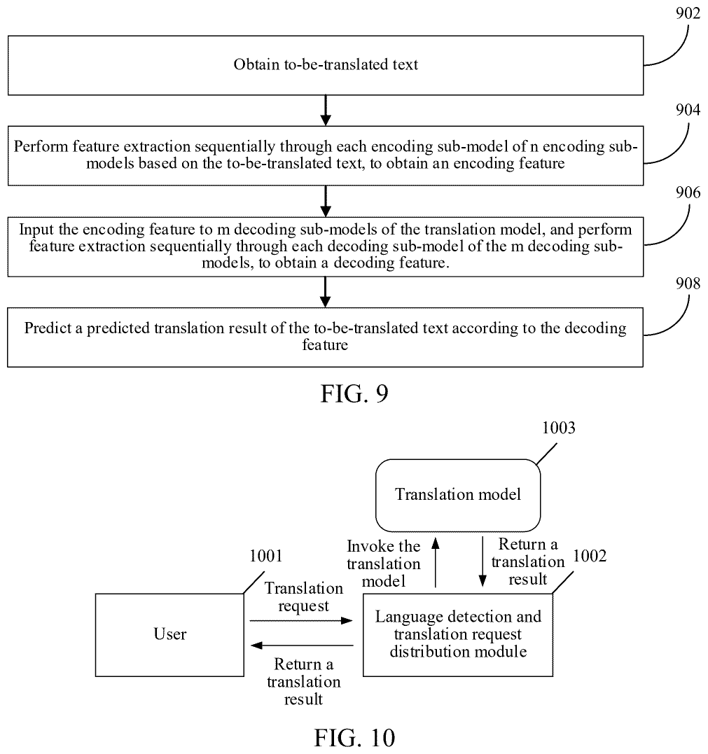

FIG. 9 is a flowchart of a text translation method based on a translation model according to an aspect of this disclosure. The method may be applied to a computer device or a client in the computer device. As shown in FIG. 9, the method includes:

Operation 902: Obtain to-be-translated text. For example, to-be-translated text is obtained.

A translation model is configured to translate text in one or more first languages into text in one or more second languages, the language corresponding to the to-be-translated text belongs to the one or more first languages, and a predicted translation result predicted by the translation model according to the to-be-translated text belongs to the one or more second languages.

In some aspects, the computer device obtains the to-be-translated text by means of local storage, the computer device obtains the to-be-translated text by means of another computer device, or the computer device obtains the to-be-translated text uploaded by a user.

Operation 904: Perform feature extraction based on the to-be-translated text sequentially by using each encoding sub-model of n encoding sub-models, to obtain an encoding feature. For example, feature extraction is performed based on the to-be-translated text sequentially through n cascaded encoding sub-models to obtain encoding features. n is a positive integer greater than or equal to 2. Each encoding sub-model of the n cascaded encoding sub-models includes a layer normalization (LayerNorm) layer and a sub-network layer connected in cascade. The feature extraction through each encoding sub-model includes extracting features sequentially through the LayerNorm layer and the sub-network layer and processing the extracted features through a residual connection between input and output positions of the LayerNorm layer of the respective encoding sub-model.

In some aspects, the computer device may input the to-be-translated sample text into the translation model. The translation model performs feature extraction on the to-be-translated sample text by using a first encoding sub-model of the n encoding sub-models, to output a feature, and then starting from second encoding sub-model of the n encoding sub-model, performs the feature extraction sequentially based on the feature outputted by a preceding encoding sub-model, until the last encoding sub-model of the n encoding sub-models outputs the encoding feature.

In some aspects, the computer device may utilize the translation model to perform the feature extraction on the to-be-translated sample text by using the first encoding sub-model of the n encoding sub-models of the translation model, to output the feature, and then starting from the second encoding sub-model of the n encoding sub-models, perform the feature extraction sequentially based on the features outputted by the encoding sub-models preceding the current encoding sub-model, until the last encoding sub-model of the n encoding sub-models outputs the encoding feature.

In some aspects, the computer device may further utilize the translation model to perform the feature extraction on the to-be-translated sample text by using the first encoding sub-model of the n encoding sub-models, to output the feature, then starting from the second encoding sub-model of the n encoding sub-models, fuse the features outputted by the encoding sub-models preceding the current encoding sub-model for feature extraction, and fuse the features outputted respectively by the n encoding sub-models, to obtain the encoding feature.

The translation model includes n cascaded encoding sub-models, each encoding sub-model includes a LayerNorm layer and a sub-network layer connected in cascade, and n is a positive integer greater than or equal to 2. Each encoding sub-model is configured to perform feature extraction sequentially through the included LayerNorm layer and sub-network layer, and process a feature extraction result of the encoding sub-model through a residual connection between input and output positions of the included LayerNorm layer.

In some aspects, the translation model includes an encoder, the encoder includes k encoding models, the k encoding models include the n cascaded encoding sub-models, each encoding model includes at least two cascaded encoding sub-models, and k is a positive integer. For example, each encoding model includes two cascaded encoding sub-models, the structure of each encoding model is the same, a sub-network layer of the first encoding sub-model of each encoding model is a multi-head self-attention network, and the sub-network layer of the second coding sub-model of each encoding model is a feed-forward fully-connected network.

Operation 906: Input the encoding feature into m decoding sub-models of the translation model, and perform feature extraction sequentially through each decoding sub-model of the m decoding sub-models, to obtain a decoding feature. For example, feature extraction is performed based on the encoding features sequentially through m cascaded decoding sub-models to obtain decoding features. m is a positive integer greater than or equal to 3. Each decoding sub-model of the m cascaded decoding sub-models includes a layer normalization (LayerNorm) layer and a sub-network layer connected in cascade. The feature extraction through each decoding sub-model includes extracting features sequentially through the LayerNorm layer and the sub-network layer and processing the extracted features through a residual connection between input and output positions of the LayerNorm layer of the respective decoding sub-model.

In some aspects, the computer device may perform decoding by using a first decoding sub-model of the m decoding sub-models, to output a feature, and then starting from the second decoding sub-model of the m decoding sub-models, perform decoding sequentially based on the feature outputted by preceding decoding sub-model, until the last decoding sub-model of the m decoding sub-models outputs the decoding feature.

In some aspects, the computer device may further perform the decoding by using the first decoding sub-model of the m decoding sub-models, to output the feature, and then starting from the second decoding sub-model of the m decoding sub-models, perform the decoding sequentially based on the features outputted by the decoding sub-models preceding the current decoding sub-model, until the last decoding sub-model of the m decoding sub-models outputs the decoding feature.

In some aspects, the computer device may further perform the decoding by using the first decoding sub-model of the m decoding sub-models, to output the feature, and then starting from the second decoding sub-model of the m decoding sub-models, sequentially fuse the features outputted by the decoding sub-models preceding the current decoding sub-model for decoding, and until the last decoding sub-model of the m decoding sub-models outputs the feature, fuse the features outputted respectively by the m decoding sub-models, to obtain the decoding feature.

The translation model includes m cascaded decoding sub-models, each decoding sub-model includes a LayerNorm layer and a sub-network layer connected in cascade, and m is a positive integer greater than or equal to 3. In some aspects, the sub-network layer is one of a feed-forward fully-connected network and a multi-head self-attention network, and the multi-head self-attention network can alternatively be one of a mask multi-head self-attention network and a cross self-attention network. The m decoding sub-models at least include a feed-forward fully-connected network, a mask multi-head self-attention network, and a cross self-attention network. The sub-network layers in two adjacent decoding sub-models are the same or different. The mask multi-head self-attention network functions similarly to the multi-head self-attention network, with a distinction that the mask multi-head self-attention network is further configured to, when generating a translation result of a word in the input feature, shield the translation result corresponding to a word after the word in the input feature.

In a process of performing the feature extraction by using the m decoding sub-models, each decoding sub-model is configured to perform the feature extraction sequentially through the included LayerNorm layer and sub-network layer, and process a feature extraction result of the decoding sub-model through the residual connection between the input and output positions of the included LayerNorm layer.

Operation 908: Predict a predicted translation result of the to-be-translated text according to the decoding feature. For example, a predicted translation result of the to-be-translated text is predicted based on the decoding features.

The computer device may predict the predicted translation result of the to-be-translated text according to the decoding feature by using the translation model. In some aspects, the translation model further includes a linear layer and a softmax layer (also referred to as a normalized exponential function layer) connected in cascade. The linear layer and the softmax layer are cascaded. The linear layer is configured to perform linear transformation on an input feature, and the softmax layer is configured to process the input feature by using a normalized exponential function. After obtaining the decoding feature, the computer device inputs the decoding feature to the linear layer, and performs the processing sequentially through the linear layer and the softmax layer, to output a translated word predicted by the translation model for each current word in the to-be-translated sample text and a probability of each translated word. The translated word is determined by the translation model in a vocabulary based on the decoding feature, and the probability of the translated word is configured for reflecting a probability that the translated word is the actual translated word. By using the vocabulary of different languages, the to-be-translated text may be translated into the translation result of the language used by the vocabulary.

For the process in which the computer device predicts the predicted translation result of the translated text through the translation model, refer to related content in the foregoing aspects of the training method for the translation model.

In conclusion, according to the method provided in this aspect, the translation model is constructed by using the encoding sub-models and the decoding sub-models. Because the LayerNorm layer in each sub-model precedes the sub-network layer, and the input and output positions of the LayerNorm layer in the sub-model have the residual connection, the residual connection of the Post-LN is introduced based on the Pre-LN. The residual connection provides a channel for stably propagating a gradient signal, which ensures that the translation model can further be successfully trained and converged as the number of layers of the translation model increases, thereby improving the stability of the model. In addition, the structure similar to the Pre-LN in the translation model can further ensure a better effect and generalization performance of the translation model. Therefore, the performance of the translation model can be improved, thereby improving the text translation quality.

In some aspects, the translation model includes k cascaded encoding models, each encoding model includes at least two cascaded encoding sub-models in the n encoding sub-models, and k is a positive integer greater than or equal to 2. The operation of performing feature extraction sequentially through each encoding sub-model of the n encoding sub-models based on the to-be-translated text, to obtain an encoding feature includes: the to-be-translated text is inputted into the first encoding model, and feature extraction is performed sequentially by using each encoding sub-model in the first encoding model, to obtain the output feature of the first encoding model; and the output feature of the i^{th} coding model is inputted to the (i+1)^{th} coding model, and feature extraction is performed sequentially by using each encoding sub-model in the (i+1)^{th} encoding model, to obtain the output feature of the (i+1)^{th} encoding model, until the k^{th} encoding model outputs the encoding feature, and i is a positive integer and i+1 is not greater than k.

In some aspects, the translation model includes k cascaded decoding models, and each decoding model includes at least three cascaded decoding sub-models of the m decoding sub-models. The operation of performing feature extraction based on the encoding feature sequentially through each decoding sub-model of the m decoding sub-models, to obtain a decoding feature includes: the encoding feature outputted by the k^{th} encoding model is inputted to the first decoding model, and the feature extraction is performed sequentially through each decoding sub-model in the first decoding model, to obtain the output feature of the first decoding model; and the output feature of the k^{th} encoding model and an output feature of the j^{th} decoding model are inputted to a (j+1)^{th} decoding model, and feature extraction is performed sequentially through each decoding sub-model in the (j+1)^{th} decoding model to obtain the output feature of the (j+1)^{th} decoding model until the k^{th} decoding model outputs the decoding feature, and j is a positive integer and j+1 is not greater than k.

In some aspects, each encoding model includes a first encoding sub-model and a second encoding sub-model connected in cascade, the sub-network layer of the first encoding sub-model is a multi-head self-attention network, and the sub-network layer of the second encoding sub-model is a feed-forward fully-connected network. The operation of inputting the output feature of the i^{th} encoding model to the (i+1)^{th} encoding model, and performing the feature extraction sequentially through each encoding sub-model in the (i+1)^{th} encoding model, to obtain the output feature of the (i+1)^{th} encoding model includes: the output feature of the i^{th} encoding model is inputted to the first encoding sub-model of the (i+1)^{th} encoding model; the feature extraction is performed sequentially through the LayerNorm layer and the multi-head self-attention network of the first encoding sub-model; the output feature of the i^{th} encoding model and the output feature of the LayerNorm layer of the first encoding sub-model are added to the output feature of the multi-head self-attention network of the first encoding sub-model through the residual connection, to obtain the output feature of the first encoding sub-model; the output feature of the first encoding sub-model is inputted to the second encoding sub-model of the (i+1)^{th} encoding model; the feature extraction is performed sequentially through the LayerNorm layer and the feed-forward fully-connected network of the second encoding sub-model; and the output feature of the first encoding sub-model and the output feature of the LayerNorm layer of the second encoding sub-model are added to the output feature of the feed-forward fully-connected network of the second encoding sub-model through the residual connection, to obtain the output feature of the (i+1)^{th} encoding model.

In some aspects, the operation of adding the output feature of the i^{th} encoding sub-model and the output feature of the LayerNorm layer of the first encoding sub-model to the output feature of the multi-head self-attention network of the first encoding sub-model through the residual connection, to obtain the output feature of the first encoding sub-model includes: the first product of the output feature of the i^{th} encoding model and the first weight is determined; the second product of the output feature of the LayerNorm layer of the first encoding sub-model and the second weight is determined; and the first product and the second product are added to the output feature of the multi-head self-attention network of the first encoding sub-model through the residual connection.

In some aspects, the operation of adding the output feature of the first encoding sub-model and the output feature of the LayerNorm layer of the second encoding sub-model to the output feature of the feed-forward fully-connected network of the second encoding sub-model through the residual connection, to obtain the output feature of the (i+1)^{th} encoding model includes: the third product of the output feature of the first encoding sub-model and the third weight is determined; the fourth product of the output feature of the LayerNorm layer of the second encoding sub-model and the fourth weight is determined; and the third product and the fourth product are added to the output feature of the feed-forward fully-connected network of the second encoding sub-model through the residual connection.

In some aspects, the text translation method based on the translation model further includes: the actual translation result of the to-be-translated text is obtained; the error between the actual translation result and the predicted translation result is determined, and at least one of the first weight, the second weight, the third weight, and the fourth weight is optimized according to the error.

In some aspects, the text translation method based on the translation model further includes: normalized processing is performed on the decoding features outputted by the m decoding sub-models, to obtain a normalized decoding feature.

In some aspects, each decoding model includes a first decoding sub-model, a second decoding sub-model, and a third decoding sub-model connected in cascade, the sub-network layer of the first decoding sub-model is a first multi-head self-attention network, the sub-network layer of the second decoding sub-model is a second multi-head self-attention network, and the sub-network layer of the third decoding sub-model is a feed-forward fully-connected network. The operation of inputting the output feature of the k^{th} encoding model and the output feature of the j^{th} decoding model to the (j+1)^{th} decoding model, and performing feature extraction sequentially through each decoding sub-model in the (j+1)^{th} decoding model, to obtain the output feature of the (j+1)^{th} decoding model includes: the output feature of the j^{th} decoding model is inputted to the first decoding sub-model of the (j+1)^{th} decoding model; the feature extraction is performed sequentially through the LayerNorm layer and the first multi-head self-attention network of the first decoding sub-model; the output feature of the j^{th} decoding model and the output feature of the LayerNorm layer of the first decoding sub-model are added to the output feature of the first multi-head self-attention network of the first decoding sub-model through the residual connection, to obtain the output feature of the first decoding sub-model; the output feature of the k^{th} encoding model and the output feature of the first decoding sub-model are inputted to the second decoding sub-model of the (j+1)^{th} decoding model; the feature extraction is performed sequentially through the LayerNorm layer and the second multi-head self-attention network of the second decoding sub-model; the output feature of the first decoding sub-model and the output feature of the LayerNorm layer of the second decoding sub-model are added to the output feature of the second multi-head self-attention network of the second decoding sub-model through the residual connection, to obtain the output feature of the second decoding sub-model; the output feature of the second decoding sub-model is inputted to the third decoding sub-model of the (j+1)^{th} decoding model; the feature extraction is performed sequentially through the LayerNorm layer and the feed-forward fully-connected network of the third decoding sub-model; and the output feature of the second decoding sub-model and the output feature of the LayerNorm layer of the third decoding sub-model are added to the output feature of the feed-forward fully-connected network of the third decoding sub-model through the residual connection, to obtain the output feature of the (j+1)^{th} decoding model.

In a specific example, the method provided in this aspect of this disclosure may be applied to various translation scenarios such as chats, moments, and picture text in an instant messaging client. For example, when a user has a conversation with friends or views news, a translation function implemented based on the method provided in this aspect of this disclosure may be used by long-pressing the text, so that the current language is translated to a language set by the user. In addition, a language direction may also be specified by using a mini program for translation.

For example, FIG. 10 is a schematic diagram of a text translation process according to an aspect of this disclosure. As shown in FIG. 10, a user 1001 triggers a translation function for text on a user interface through the user interface of the instant messaging client. The client transmits a translation request to a language detection and translation request distribution module 1002 of a server. The request includes to-be-translated text, and may further include a language that needs to be translated. The module 1002 detects the language of the to-be-translated text and obtains the language that needs to be translated, so as to invoke a translation model 1003 to translate the to-be-translated text, to obtain a translation result. Then, the translation result is fed back to the user 1001, and the instant messaging client of the user may display the translation result.

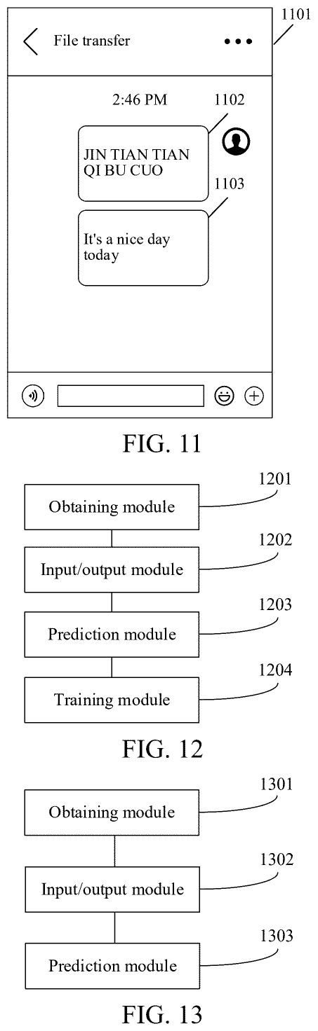

For example, FIG. 11 is a schematic diagram of a chat interface according to an aspect of this disclosure. As shown in FIG. 11, an instant messaging client displays a user interface 1101. The user interface 1101 displays chat information 1102. In some aspects, a user performs an interaction operation on the displayed chat information 1102, and may trigger the translation of the chat information 1102. After obtaining a translation result 1103 of the chat information 1102, the client may display the translation result 1103 on the user interface 1101.

For example, in this aspect of this disclosure, an overall translation process involves first segmenting a received sentence into individual clauses, followed by performing word segmentation on each clause. For example, the sentence “WO AI ZHONGGUO (I love China)” is segmented into “WO/AI/ZHONGGUO”. Then, the segmented words are transmitted to a translation model, and the translation model outputs corresponding translated text. Subsequently, the computer device performs simple post-processing on punctuations, spaces, and the like of the translated text, and then returns the translated text.

The translation model provided in this aspect of this disclosure integrates the structures of Pre-LN and Post-LN, to integrate advantages of the two, thereby improving the training stability of the translation model and improving the effect. Further referring to FIG. 2, a structure difference between the Pre-LN and the Post-LN mainly lies in different positions of the LayerNorm layer and residual connection. The two structures, such as the structures in FIG. 7 and FIG. 8, are combined to obtain the translation model provided in this aspect of this disclosure. The structure of each sub-model may be simplified to the structure in FIG. 4.

The model in this aspect of this disclosure is trained by using bilingual data (such as English-Chinese) of a pair of languages (or a plurality of languages), to obtain the translation model. Subsequently, the translation model is deployed to an online service, receives an online translation request, performs model inference, and returns the translated text.

In addition, in this aspect of this disclosure, the translation model integrating the Pre-LN and Post-LN has relatively straightforward hardware environment requirements, and can be trained and deployed for online use with a conventional server environment. For details, refer to Table 1. Table 1 shows a software and hardware environment involved in implementing the translation model.

TABLE 1

| Operating system | Internal memory | Language environment |
|---|---|---|
| Linux | >16 G | Python/c++ |

The translation model provided in this aspect of this disclosure can achieve a balance between training stability and performance. Compared with the Post-LN, the translation model can stably train an extremely deep (1000 layers) model. In addition, compared with the Pre-LN, the translation model can improve the effect that is comparable to the effect of the Post-LN. The translation model provided in this aspect of this disclosure is an effective solution for training a deep translation model.

In addition, the translation model provided in this aspect of this disclosure not only can obtain the stability of the Pre-LN, but also reserve the structure of the Post-LN, thereby having no limitation to the updating quantity of the model in a training process, and releasing more potential of the model. By using the method provided in this aspect of this disclosure, the model structure is changed slightly. This method may be used in combination with other solutions (such as increasing local attention and knowledge distillation) for improving the model effect, to further improve the model effect.

A beneficial effect of the translation model provided in this aspect of this disclosure is as follows (Table 2 lists a “BLEU” indicator, where the indicator is a standard machine translation evaluation method, and a higher value indicates a better effect):

TABLE 2

| Model | 200 layers | 100 layers |
|---|---|---|
| Pre-LN | 30.5 | 31.0 |
| Post-LN | Fail | Fail |
| DeepNet | 31.1 (+0.6) | 32.1 (+1.1) |
| Translation model of this application | 31.5 (+1.0) | 32.3 (+1.3) |

In addition, the model provided in this aspect of this disclosure is not only applicable to a machine translation scenario. At present, a transformer model is a mainstream model in the field of natural language processing, and includes a large language model (LLM), sentiment analysis, a machine abstract, and the like.

In addition, a sequence of the operations of the method provided in the aspects of this disclosure may be appropriately adjusted, and the operations may also be correspondingly added or deleted in different situations. All variant methods readily figured out by a person skilled in the related art within the technical scope disclosed in this disclosure shall fall within the scope of this disclosure, and therefore are not described in detail.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

FIG. 12 is a schematic structural diagram of a training apparatus for a translation model according to an aspect of this disclosure. The translation model includes n cascaded encoding sub-models and m cascaded decoding sub-models, each encoding sub-model and each decoding sub-model include a LayerNorm layer and a sub-network layer connected in cascade, n is a positive integer greater than or equal to 2, and m is a positive integer greater than or equal to 3. As shown in FIG. 12, the apparatus includes:
an obtaining module 1201, configured to obtain sample text;
an input/output module 1202, configured to perform feature extraction based on the sample text sequentially through each encoding sub-model of the n encoding sub-models, to obtain an encoding feature, where each encoding sub-model is configured to perform feature extraction sequentially through the included LayerNorm layer and sub-network layer, and process a feature extraction result of the encoding sub-model through a residual connection between input and output positions of the included LayerNorm layer; and
the input/output module 1202 is further configured to perform feature extraction based on the encoding feature sequentially through each decoding sub-model of the m decoding sub-models, to obtain a decoding feature, where each decoding sub-model is configured to perform the feature extraction sequentially through the included LayerNorm layer and sub-network layer, and process the feature extraction result of the decoding sub-model through the residual connection;
a prediction module 1203, configured to predict a sample translation result of the sample text according to the decoding feature; and
a training module 1204, configured to obtain an actual translation result of the sample text, determine an error between the actual translation result and the sample translation result, and update a model parameter of the translation model according to the error.

In an alternative design, the translation model includes k cascaded encoding models, each encoding model includes at least two cascaded encoding sub-models of the n encoding sub-models, and k is a positive integer greater than or equal to 2; the input/output module 1202 is configured to
input the sample text to a first encoding model, and perform the feature extraction sequentially through each encoding sub-model in the first encoding model, to obtain an output feature of the first encoding model;
input an output feature of an i^{th} encoding model to an (i+1)^{th} encoding model, and perform the feature extraction sequentially through each encoding sub-model in the (i+1)^{th} encoding model, to obtain an output feature of the (i+1)^{th} encoding model, until a k^{th} encoding model outputs the encoding feature, i is a positive integer and i+1 is not greater than k; and
the translation model includes k cascaded decoding models, and each decoding model includes at least three cascaded decoding sub-models of the m decoding sub-models; and
the input/output module 1202 is configured to input the encoding feature outputted by the k^{th} encoding model to the first decoding model, and perform the feature extraction sequentially through each decoding sub-model in the first decoding model, to obtain an output feature of the first decoding model; and
input the output feature of the k^{th} encoding model and the output feature of the j^{th} decoding model to the (j+1)^{th} decoding model, and perform the feature extraction sequentially through each decoding sub-model in the (j+1)^{th} decoding model to obtain the output feature of the (j+1)^{th} decoding model, until the k^{th} decoding model outputs the decoding feature, and j is a positive integer and j+1 is not greater than k.

In an alternative design, each encoding model includes a first encoding sub-model and a second encoding sub-model connected in cascade, a sub-network layer of the first encoding sub-model is a multi-head self-attention network, and the sub-network layer of the second encoding sub-model is a feed-forward fully-connected network; and the input/output module 1202 is configured to
input the output feature of the i^{th} encoding model to the first encoding sub-model of the (i+1)^{th} encoding model;
perform the feature extraction sequentially through the LayerNorm layer and the multi-head self-attention network of the first encoding sub-model;
add the output feature of the i^{th} encoding model and the output feature of the LayerNorm layer of the first encoding sub-model to the output feature of the multi-head self-attention network of the first encoding sub-model through the residual connection, to obtain the output feature of the first encoding sub-model;
input the output feature of the first encoding sub-model to the second encoding sub-model of the (i+1)^{th} encoding model;
perform the feature extraction sequentially through the LayerNorm layer and the feed-forward fully-connected network of the second coding sub-model; and
add the output feature of the first encoding sub-model and the output feature of the LayerNorm layer of the second encoding sub-model to the output feature of the feed-forward fully-connected network of the second encoding sub-model through the residual connection, to obtain the output feature of the (i+1)^{th} encoding model.

In an alternative design, the input/output module 1202 is configured to:
determine a first product of the output feature of the i^{th} encoding model and a first weight; determine a second product of the output feature of the LayerNorm layer of the first encoding sub-model and a second weight; and
add the first product and the second product to the output feature of the multi-head self-attention network of the first encoding sub-model through the residual connection;
determine a third product of the output feature of the first encoding sub-model and a third weight; determine a fourth product of the output feature of the LayerNorm layer of the second encoding sub-model and a fourth weight; and
add the third product and the fourth product to the output feature of the feed-forward fully-connected network of the second encoding sub-model through the residual connection.

In an alternative design, the training module 1204 is configured to:
obtain an actual translation result of the sample text, determine an error between the actual translation result and the sample translation result, and optimize at least one of the first weight, the second weight, the third weight, and the fourth weight according to the error.

In an alternative design, the input/output module 1202 is configured to:
perform normalized processing on the decoding features outputted by the m decoding sub-models, to obtain a normalized decoding feature.

In an alternative design, each decoding model includes a first decoding sub-model, a second decoding sub-model, and a third decoding sub-model connected in cascade, the sub-network layer of the first decoding sub-model is a first multi-head self-attention network, the sub-network layer of the second decoding sub-model is a second multi-head self-attention network, and the sub-network layer of the third decoding sub-model is a feed-forward fully-connected network; and the input/output module 1202 is configured to
input the output feature of the j^{th} decoding model to the first decoding sub-model of the (j+1)^{th} decoding model;
perform feature extraction sequentially through the LayerNorm layer and the first multi-head self-attention network of the first decoding sub-model;
add the output feature of the j^{th} decoding model and the output feature of the LayerNorm layer of the first decoding sub-model to the output feature of the first multi-head self-attention network of the first decoding sub-model through the residual connection, to obtain the output feature of the first decoding sub-model;
input the output feature of the k^{th} encoding model and the output feature of the first decoding sub-model to the second decoding sub-model of the (j+1)^{th} decoding model;
perform feature extraction sequentially through the LayerNorm layer and the second multi-head self-attention network of the second decoding sub-model;
add the output feature of the first decoding sub-model and the output feature of the LayerNorm layer of the second decoding sub-model to the output feature of the second multi-head self-attention network of the second decoding sub-model through the residual connection, to obtain the output feature of the second decoding sub-model;
input the output feature of the second decoding sub-model to the third decoding sub-model of the (j+1)^{th} decoding model;
perform feature extraction sequentially through the LayerNorm layer and the feed-forward fully-connected network of the third decoding sub-model; and
add the output feature of the second decoding sub-model and the output feature of the LayerNorm layer of the third decoding sub-model to the output feature of the feed-forward fully-connected network of the third decoding sub-model through the residual connection, to obtain the output feature of the (j+1)^{th} decoding model.

In an alternative design, the training module 1204 is configured to:
set the number of model parameters updated by the translation model in each iteration to not exceed a quantity threshold in the case that the number of training iterations of the translation model does not exceed a first threshold; and
cancel the setting of the quantity threshold in the case that the number of training iterations of the translation model is not less than a second threshold, where the second threshold is greater than the first threshold.

FIG. 13 is a schematic structural diagram of a text translation apparatus based on a translation model according to an aspect of this disclosure. The translation model includes n cascaded encoding sub-models and m cascaded decoding sub-models, each encoding sub-model and each decoding sub-model include a LayerNorm layer and a sub-network layer connected in cascade, n is a positive integer greater than or equal to 2, and m is a positive integer greater than or equal to 3. As shown in FIG. 13, the apparatus includes:
an obtaining module 1301, configured to obtain to-be-translated text;
an input/output module 1302, configured to perform feature extraction based on the to-be-translated text sequentially through each encoding sub-model of the n encoding sub-models, to obtain an encoding feature, where each encoding sub-model is configured to perform feature extraction sequentially through the included LayerNorm layer and sub-network layer, and process a feature extraction result of the encoding sub-model through a residual connection between input and output positions of the included LayerNorm layer; and
the input/output module 1302 is further configured to perform the feature extraction sequentially through each decoding sub-model of the m decoding sub-models based on the encoding feature, to obtain a decoding feature, where each decoding sub-model is configured to perform the feature extraction sequentially through the included LayerNorm layer and sub-network layer, and process a feature extraction result of the decoding sub-model through the residual connection; and
a prediction module 1303, configured to predict a predicted translation result of the to-be-translated text according to the decoding feature.

In addition, the training apparatus for the translation model provided in the foregoing aspect is illustrated only with an example of division of the foregoing function modules. In practical applications, the foregoing functions may be allocated to and completed by different function modules according to requirements. Namely, the internal structure of the apparatus is divided into different function modules to complete all or some of the functions described above. In addition, the training apparatus for the translation model provided in the foregoing aspects and the method aspects for the translation model belong to the same concept. For details of a specific implementation process, refer to the method aspects. Details are not described herein again.

Similarly, the text translation apparatus based on the translation model provided in the foregoing aspects is illustrated only with an example of division of the foregoing function modules. In practical applications, the foregoing functions may be allocated to and completed by different function modules according to requirements. Namely, the internal structure of the apparatus is divided into different function modules to complete all or some of the functions described above. In addition, the text translation apparatus based on the translation model provided in the foregoing aspects and the text translation method aspects based on the translation model belong to the same concept. For details of a specific implementation process, refer to the method aspects. Details are not described herein again.

An aspect of this disclosure further provides a computer device. The computer device includes: a processor (e.g., processing circuitry) and a memory (e.g., a non-transitory computer-readable storage medium). The memory has at least one instruction, at least one program, and a code set or an instruction set stored therein, and the at least one instruction, the at least one program, and the code set or the instruction set are loaded and executed by the processor to implement the training method for the translation model or the text translation method based on the translation model provided in various foregoing method aspects.

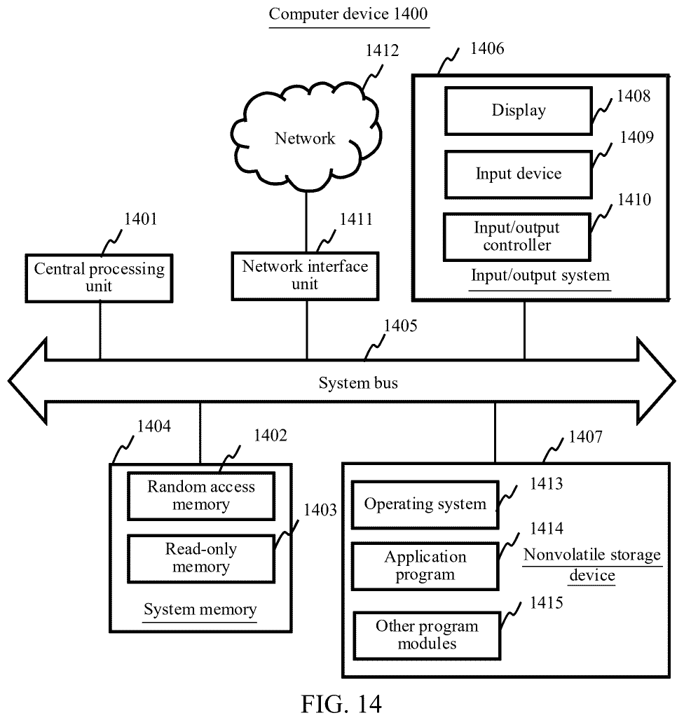

In some aspects, the computer device is a server. FIG. 14 is a schematic structural diagram of a computer device according to an aspect of this disclosure.

The computer device 1400 includes a central processing unit (CPU) 1401, a system memory 1404 including a random access memory (RAM) 1402 and a read-only memory (ROM) 1403, and a system bus 1405 connecting the system memory 1404 and the CPU 1401. The computer device 1400 further includes a basic input/output (I/O) system 1406 assisting in information transmission between components in the computer device, and a non-volatile storage device 1407 configured to store an operating system 1413, an application program 1414, and another program module 1415.

The basic I/O system 1406 includes a display 1408 configured to display information and an input device 1409 such as a mouse or a keyboard that is used for a user to input the information. The display 1408 and the input device 1409 are both connected to the CPU 1401 by using an input/output controller 1410 connected to the system bus 1405. The basic I/O system 1406 may further include the input/output controller 1410 for receiving and processing inputs from a plurality of other devices such as a keyboard, a mouse, and an electronic stylus. Similarly, the input/output controller 1410 further provides an output to a display screen, a printer, or another type of output device.

The non-volatile storage device 1407 is connected to the CPU 1401 by using a storage controller (not shown) connected to the system bus 1405. The non-volatile storage device 1407 and a computer-readable storage medium associated therewith provide non-volatile storage for the computer device 1400. In other words, the non-volatile storage device 1407 may include a computer-readable storage medium (not shown) such as a hard disk or a compact disc read-only memory (CD-ROM) drive.

Without loss of generality, the computer-readable storage medium such as a non-transitory computer-readable storage medium may include a computer storage medium and a communication medium. The computer storage medium includes volatile and non-volatile media, and removable and non-removable media implemented by using any method or technology used for storing information such as computer-readable storage instructions, data structures, program modules, or other data. The computer storage medium includes a RAM, an erasable programmable ROM (EPROM), an electrically-erasable programmable ROM (EEPROM), a flash memory or another solid-state memory technology, a CD-ROM, a digital versatile disc (DVD) or another optical memory, a magnetic cassette, a magnetic tape, a magnetic disk memory, or another magnetic storage device. Certainly, a person skilled in the art may learn that the computer storage medium is not limited to the foregoing several types. The system memory 1404 and the non-volatile storage device 1407 may be collectively referred to as a memory.

The memory stores one or more programs. The one or more programs are configured for being executed by one or more CPUs 1401. The one or more programs include an instruction configured for implementing the foregoing methods. The CPU 1401 executes the one or more programs to implement the methods provided in the foregoing method aspects.

According to the aspects of this disclosure, the computer device 1400 may further be connected to a remote computer on the network and run through a network such as the Internet. To be specific, the computer device 1400 may be connected to a network 1412 by using a network interface unit 1411 connected to the system bus 1405, or may be connected to another type of network or a remote computer device system (not shown) by using a network interface unit 1411.

The memory further includes one or more programs, where the one or more programs are stored in the memory, and include operations that are configured for performing the method provided in the aspects of this disclosure and performed by the computer device.

An aspect of this disclosure further provides a computer-readable storage medium. The readable storage medium has at least one instruction, at least one program, and a code set or an instruction set stored therein, and the at least one instruction, the at least one program, and the code set or the instruction set are loaded and executed by a processor of a computer device to implement the training method for the translation model or the text translation method based on the translation model provided in the foregoing method aspects.

An aspect of this disclosure further provides a computer program product or a computer program. The computer program product or the computer program includes a computer instruction stored in a computer-readable storage medium. A processor of a computer device reads the computer instruction from the computer-readable storage medium, and the processor executes the computer instruction to enable the computer device to implement the training method for the translation model or the text translation method based on the translation model provided in the foregoing method aspects.

Technical features of the foregoing aspects may be combined in any manner. To make description concise, not all possible combinations of the technical features in the foregoing aspects are described. However, the combinations of these technical features shall be considered as falling within the scope recorded by this specification provided that no conflict exists.

The foregoing aspects only describe several implementations of this disclosure, which are described in detail, but cannot be construed as a limitation to the patent scope of this disclosure. For a person of ordinary skill in the art, several transformations and improvements may be made without departing from the idea of this disclosure. These transformations and improvements belong to the scope of this disclosure.

What is claimed is:

1. A method for training a translation model, the method comprising:
obtaining sample text;
performing feature extraction based on the sample text sequentially through n cascaded encoding sub-models to obtain encoding features, n being a positive integer greater than or equal to 2, each encoding sub-model of the n cascaded encoding sub-models including a layer normalization (LayerNorm) layer and a sub-network layer connected in cascade, the feature extraction through each encoding sub-model including extracting features sequentially through the LayerNorm layer and the sub-network layer, and processing the extracted features through a residual connection between input and output positions of the LayerNorm layer of the respective encoding sub-model;
performing feature extraction based on the encoding features sequentially through m cascaded decoding sub-models to obtain decoding features, m being a positive integer greater than or equal to 3, each decoding sub-model of the m cascaded decoding sub-models including a layer normalization (LayerNorm) layer and a sub-network layer connected in cascade, the feature extraction through each decoding sub-model including extracting features sequentially through the LayerNorm layer and the sub-network layer, and processing the extracted features through a residual connection between input and output positions of the LayerNorm layer of the respective decoding sub-model;
predicting a sample translation result of the sample text based on the decoding features;
obtaining a reference translation result of the sample text;
determining an error between the reference translation result and the sample translation result; and
updating a model parameter of the translation model according to the error.

2. The method according to claim 1, wherein
the translation model includes k cascaded encoding models, each encoding model of the k cascaded encoding models including at least two encoding sub-models of the n cascaded encoding sub-models, k being a positive integer greater than or equal to 2; and
the performing the feature extraction based on the sample text comprises:
inputting the sample text into a first encoding model of the k cascaded encoding models;
performing feature extraction sequentially through each encoding sub-model in the first encoding model to obtain an output feature of the first encoding model; and
inputting an output feature of the first encoding model to a second encoding model of the k cascaded encoding models.

3. The method according to claim 2, wherein
the translation model includes k cascaded decoding models, and each decoding model of the k cascaded decoding models includes at least three decoding sub-models of the m cascaded decoding sub-models; and
the performing the feature extraction based on the encoding features comprises:
inputting the encoding features from a k^{th} encoding model to a first decoding model of the k cascaded decoding models;
performing feature extraction sequentially through each decoding sub-model in the first decoding model to obtain output features of the first decoding model; and
inputting the encoding features from the k^{th} encoding model and an output feature of the first decoding model to a second decoding model of the k cascaded decoding models.

4. The method according to claim 3, wherein
each encoding model of the k cascaded encoding models includes a first encoding sub-model and a second encoding sub-model connected in cascade, the sub-network layer of the first encoding sub-model being a multi-head self-attention network, and the sub-network layer of the second encoding sub-model being a feed-forward fully-connected network; and
the performing the feature extraction sequentially through each encoding sub-model comprises:
inputting the output features of the first encoding model to the first encoding sub-model of the second encoding model;
performing feature extraction sequentially through the LayerNorm layer and the multi-head self-attention network of the first encoding sub-model to generate first intermediate features;
adding the output features of the first encoding model, output features of the LayerNorm layer of the first encoding sub-model, and the first intermediate features through the residual connection to obtain output features of the first encoding sub-model;
inputting the output features of the first encoding sub-model to the second encoding sub-model of the second encoding model;
performing feature extraction sequentially through the LayerNorm layer and the feed-forward fully-connected network of the second encoding sub-model to generate second intermediate features; and
adding the output features of the first encoding sub-model, output features of the LayerNorm layer of the second encoding sub-model, and the second intermediate features through the residual connection to obtain the output features of the second encoding model.

5. The method according to claim 4, wherein the adding the output feature of the first encoding model, the output feature of the LayerNorm layer of the first encoding sub-model, and the first intermediate features comprises:
determining a first product based on the output features of the first encoding model and a first weight;
determining a second product based on the output features of the LayerNorm layer of the first encoding sub-model and a second weight;
determining a first sum by adding the first product and the second product; and
adding the first sum to the first intermediate features to obtain the output features of the first encoding sub-model.

6. The method according to claim 5, wherein the adding the output features of the first encoding sub-model, the output features of the LayerNorm layer of the second encoding sub-model, and the second intermediate features comprises:
determining a third product based on the output features of the first encoding sub-model and a third weight;
determining a fourth product based on the output features of the LayerNorm layer of the second encoding sub-model and a fourth weight;
determining a second sum by adding the third product and the fourth product; and
adding the second sum to the second intermediate features to obtain the output features of the second encoding model.

7. The method according to claim 6, wherein the updating the model parameter of the translation model based on the error comprises:
optimizing at least one of the first weight, the second weight, the third weight, and the fourth weight based on the error between the reference translation result and the sample translation result.

8. The method according to claim 1, further comprising:
performing normalized processing on the decoding features to generate normalized decoding features; and
wherein the predicting the sample translation result includes predicting the sample translation result based on the normalized decoding features.

9. The method according to claim 3, wherein
each decoding model of the k cascaded decoding models includes a first decoding sub-model, a second decoding sub-model, and a third decoding sub-model connected in cascade, the sub-network layer of the first decoding sub-model being a mask multi-head self-attention network, the sub-network layer of the second decoding sub-model being a cross self-attention network, and the sub-network layer of the third decoding sub-model being a feed-forward fully-connected network; and
the method further comprises:
inputting the output features of the first decoding model to the first decoding sub-model of the second decoding model;
performing feature extraction sequentially through the LayerNorm layer and the mask multi-head self-attention network of the first decoding sub-model to generate first decoding intermediate features;
adding the output features of the first decoding model, the output features of the LayerNorm layer of the first decoding sub-model, and the first decoding intermediate features through the residual connection to obtain the output features of the first decoding sub-model;
inputting the encoding features from the first encoding model and the output feature of the first decoding sub-model to the second decoding sub-model of the second decoding model;
performing feature extraction sequentially through the LayerNorm layer and the cross self-attention network of the second decoding sub-model to generate second decoding intermediate features;
adding the output features of the first decoding sub-model, the output features of the LayerNorm layer of the second decoding sub-model, and the second decoding intermediate features through the residual connection, to obtain the output features of the second decoding sub-model;
inputting the output features of the second decoding sub-model to the third decoding sub-model of the second decoding model;
performing feature extraction sequentially through the LayerNorm layer and the feed-forward fully-connected network of the third decoding sub-model to generate third decoding intermediate features; and
adding the output features of the second decoding sub-model, the output features of the LayerNorm layer of the third decoding sub-model, and the third decoding intermediate features through the residual connection to obtain the output features of the second decoding model.

10. The method according to claim 1, wherein
when a number of training iterations is less than a first threshold, model parameter updates are limited to a maximum number of model parameters to be updated in each training iteration to a quantity threshold; and
when the number of training iterations reaches a second threshold, the limitation on model parameter updates is removed, the second threshold being greater than the first threshold.

11. The method according to claim 1, wherein the predicting the sample translation result comprises:
inputting at least a decoding feature of the decoding features into a linear layer to generate a transformed feature;
applying a softmax layer to the transformed feature to compute a probability distribution over a vocabulary based on a normalized exponential function; and
outputting, for each word position of the sample text, a predicted translated word and a probability of the predicted translated word.

12. The method according to claim 9, wherein
the mask multi-head self-attention network is configured to prevent access to future word positions when generating a translation for a current word position;
the cross self-attention network is configured to receive, as key and query inputs, the encoding features from the k^{th} encoding model and to receive, as a value input, the output features of the first decoding sub-model; and
the feed-forward fully-connected network is configured to perform a nonlinear transformation on input features received by the feed-forward fully-connected network.

13. A text translation method using a translation model, comprising:
obtaining to-be-translated text;
performing feature extraction based on the to-be-translated text sequentially through n cascaded encoding sub-models to obtain encoding features, n being a positive integer greater than or equal to 2, each encoding sub-model of the n cascaded encoding sub-models including a layer normalization (LayerNorm) layer and a sub-network layer connected in cascade, the feature extraction through each encoding sub-model including extracting features sequentially through the LayerNorm layer and the sub-network layer, and processing the extracted features through a residual connection between input and output positions of the LayerNorm layer of the respective encoding sub-model;
performing feature extraction based on the encoding features sequentially through m cascaded decoding sub-models to obtain decoding features, m being a positive integer greater than or equal to 3, each decoding sub-model of the m cascaded decoding sub-models including a layer normalization (LayerNorm) layer and a sub-network layer connected in cascade, the feature extraction through each decoding sub-model including extracting features sequentially through the LayerNorm layer and the sub-network layer, and processing the extracted features through a residual connection between input and output positions of the LayerNorm layer of the respective decoding sub-model; and
predicting a predicted translation result of the to-be-translated text based on the decoding features.

14. The method according to claim 13, wherein
the translation model includes k cascaded encoding models, each encoding model of the k cascaded encoding models including at least two encoding sub-models of the n cascaded encoding sub-models, k being a positive integer greater than or equal to 2; and
the performing the feature extraction based on the to-be-translated text comprises:
inputting the to-be-translated text into a first encoding model of the k cascaded encoding models;
performing feature extraction sequentially through each encoding sub-model in the first encoding model to obtain an output feature of the first encoding model; and
inputting an output feature of the first encoding model to a second encoding model of the k cascaded encoding models.

15. The method according to claim 14, wherein
the translation model includes k cascaded decoding models, and each decoding model of the k cascaded decoding models includes at least three decoding sub-models of the m cascaded decoding sub-models; and
the performing the feature extraction based on the encoding features comprises:
inputting the encoding features from a k^{th} encoding model to a first decoding model of the k cascaded decoding models;
performing feature extraction sequentially through each decoding sub-model in the first decoding model to obtain output features of the first decoding model; and
inputting the encoding features from the k^{th} encoding model and an output feature of the first decoding model to a second decoding model of the k cascaded decoding models.

16. The method according to claim 15, wherein
each encoding model of the k cascaded encoding models includes a first encoding sub-model and a second encoding sub-model connected in cascade, the sub-network layer of the first encoding sub-model being a multi-head self-attention network, and the sub-network layer of the second encoding sub-model being a feed-forward fully-connected network; and
the performing the feature extraction sequentially through each encoding sub-model comprises:
inputting the output features of the first encoding model to the first encoding sub-model of the second encoding model;
performing feature extraction sequentially through the LayerNorm layer and the multi-head self-attention network of the first encoding sub-model to generate first intermediate features;
adding the output features of the first encoding model, output features of the LayerNorm layer of the first encoding sub-model, and the first intermediate features through the residual connection to obtain output features of the first encoding sub-model;
inputting the output features of the first encoding sub-model to the second encoding sub-model of the second encoding model;
performing feature extraction sequentially through the LayerNorm layer and the feed-forward fully-connected network of the second encoding sub-model to generate second intermediate features; and
adding the output features of the first encoding sub-model, output features of the LayerNorm layer of the second encoding sub-model, and the second intermediate features through the residual connection to obtain the output features of the second encoding model.

17. The method according to claim 16, wherein the adding the output feature of the first encoding model, the output feature of the LayerNorm layer of the first encoding sub-model, and the first intermediate features comprises:
determining a first product based on the output features of the first encoding model and a first weight;
determining a second product based on the output features of the LayerNorm layer of the first encoding sub-model and a second weight;
determining a first sum by adding the first product and the second product; and
adding the first sum to the first intermediate features to obtain the output features of the first encoding sub-model.

18. The method according to claim 17, wherein the adding the output features of the first encoding sub-model, the output features of the LayerNorm layer of the second encoding sub-model, and the second intermediate features comprises:
determining a third product based on the output features of the first encoding sub-model and a third weight;
determining a fourth product based on the output features of the LayerNorm layer of the second encoding sub-model and a fourth weight;
determining a second sum by adding the third product and the fourth product; and
adding the second sum to the second intermediate features to obtain the output features of the second encoding model.

19. A text translation apparatus using a translation model, comprising:
processing circuitry configured to:
obtain to-be-translated text;
perform feature extraction based on the to-be-translated text sequentially through n cascaded encoding sub-models to obtain encoding features, n being a positive integer greater than or equal to 2, each encoding sub-model of the n cascaded encoding sub-models including a layer normalization (LayerNorm) layer and a sub-network layer connected in cascade, the feature extraction through each encoding sub-model including extracting features sequentially through the LayerNorm layer and the sub-network layer, and processing the extracted features through a residual connection between input and output positions of the LayerNorm layer of the respective encoding sub-model;
perform feature extraction based on the encoding features sequentially through m cascaded decoding sub-models to obtain decoding features, m being a positive integer greater than or equal to 3, each decoding sub-model of the m cascaded decoding sub-models including a layer normalization (LayerNorm) layer and a sub-network layer connected in cascade, the feature extraction through each decoding sub-model including extracting features sequentially through the LayerNorm layer and the sub-network layer, and processing the extracted features through a residual connection between input and output positions of the LayerNorm layer of the respective decoding sub-model; and
predict a predicted translation result of the to-be-translated text based on the decoding features.

20. The apparatus according to claim 19, wherein
the translation model includes k cascaded encoding models, each encoding model of the k cascaded encoding models including at least two encoding sub-models of the n cascaded encoding sub-models, k being a positive integer greater than or equal to 2; and
the processing circuitry is configured to:
input the to-be-translated text into a first encoding model of the k cascaded encoding models;
perform feature extraction sequentially through each encoding sub-model in the first encoding model to obtain an output feature of the first encoding model; and
input an output feature of the first encoding model to a second encoding model of the k cascaded encoding models.
